(19) United States
(12) Patent Application Publication
(10) Pub. No.: US 2018/0028029 A1
(43) Pub. Date: Feb. 1, 2018

(54) DRYING APPARATUS COMPRISING A HYDROPHOBIC MATERIAL

(71) Applicants: Atieh Haghdoost, San Pablo, CA (US); Mehdi Kargar, San Pablo, CA (US)

(72) Inventors: Atieh Haghdoost, San Pablo, CA (US); Mehdi Kargar, San Pablo, CA (US)

(21) Appl. No.: 15/614,050

(22) Filed: Jun. 5, 2017

Related U.S. Application Data
(63) Continuation-in-part of application No. 15/392,330, filed on Dec. 28, 2016.
Application No. 15/392,330 is a continuation-in-part of application No. 15/467,469, filed on Mar. 23, 2017.
(60) Provisional application No. 62/345,309, filed on Jun. 3, 2016.
(60) Provisional application No. 62/361,288, filed on Jul. 12, 2016.

(51) Int. Cl. A47K 10/48; F26B 25/16

(52) U.S. Cl. CPC A47K 10/48; F26B 25/16

(57) ABSTRACT

Certain embodiments are directed to a drying apparatus comprising a hydrophobic material or hydrophobic coating. In some examples, the hydrophobic material comprises a textured layer or coating. In other configurations, an additional surface layer or coating may also be disposed on the textured layer or coating.

### PRIORITY CLAIM

This application claims priority to, and the benefit of, U.S. Provisional Application No. 62/345,309 filed on Jun. 3, 2016, to U.S. Provisional Application No. 62/361,288 filed on Jul. 12, 2016, and is a continuation-in-part of U.S. application Ser. No. 15/392,330 filed on Dec. 28, 2016, and is a continuation-in-part of U.S. application Ser. No. 15/467,469 filed on Mar. 23, 2017, the entire disclosure of each of which is hereby incorporated herein by reference for all purposes.

### TECHNOLOGICAL FIELD

Certain configurations described herein are directed to drying apparatus. More particularly, certain embodiments are directed to a hand drying apparatus including a cavity in which at least a portion of the cavity comprises a hydrophobic material.

### BACKGROUND

Many articles are coated with one or more materials to impart some functional or aesthetic characteristics to the article. The coatings can be deposited in numerous ways.

### SUMMARY

Certain aspects and features of various configurations of drying apparatus are described below.

In one aspect, a drying apparatus configured to provide a gas flow to remove liquid droplets from an object comprises a drying cavity comprising an inner wall surface, wherein at least some portion of the inner wall surface comprises a hydrophobic material, wherein at least 90 percent of the surface of the hydrophobic material remains free of the liquid droplets after the drying operation.

In certain instances, the drying apparatus comprise a heater. In other instances, the drying apparatus comprises a jet configured to provide a high pressure airstream to dry the received portion of the object.

In some examples, the hydrophobic material is a coating applied on all or some parts of the inner wall surface of the drying cavity. In certain configurations, the hydrophobic material is present in an elastic sheet applied on some portion of the drying cavity. In other examples, the hydrophobic material is present on all exterior surfaces of the hand dryer.

In some instances, the drying apparatus is configured as a hand dryer. For example, the drying cavity is sized and arranged to receive a portion of a human hand.

In certain instances, the hydrophobic material comprises a textured surface comprising a plurality of individual surface features in a micro- or nano-structure size range.

In some examples, the drying apparatus comprises an additional layer disposed on the textured surface, wherein the additional layer comprises a lubricant, a polymer blend, nanoparticles, or any combination thereof such as polymer-nanoparticle composite materials is infused inside the surface features of the textured surface. In some embodiments, the additional layer comprises the nanoparticles and the nanoparticles are either treated with a low surface energy material in advance or a low surface energy material is added to the chemical blend of the additional layer. In certain examples, the nanoparticles are selected from the group comprising PTFE particles, silica particles, alumina particles, silicon carbide, diatomaceous earth, boron nitride, titanium oxide, platinum oxide, diamond, particles formed from differential etching of spinodally decomposed glass, single wall carbon nanotubes, mix silicon/titanium oxide particles (TiO2/SiO2, titanium inner core/silicon outer surface), ceramic particles, thermo-chromic metal oxide, multi-wall carbon nanotubes, kaolin (Al2O3.2SiO2.2H2O), any chemically or physically modified versions of the foregoing particles, and any combinations thereof. In other examples, the additional layer comprises the nanoparticles and wherein the nanoparticles comprise hydrophobic ceramic-based particles selected from the group including but not limited to hydrophobic fumed silica particles, hydrophobic diatomaceous earth (DE) particles, hydrophobic pyrogenic silica particles or any combination thereof.

In certain configurations, the hydrophobic material (either the textured surface or the additional layer) comprises one or more of (i) an inorganic compound selected from the group consisting of ceramics, metallic compounds, inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, inorganic fluorides, and a combination comprising at least one of the foregoing inorganic compounds; or (ii) organic or inorganic-organic compounds selected from the group consisting of silane derivatives, fluorine derivatives, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), and a combination comprising at least one of the foregoing organic or inorganic-organic compounds; or (iii) a polymer selected from the group consisting of a fluoropolymer, a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyurethane, an ethylene propylene diene rubber, a polytetrafluoroethylene, a perfluoroelastomer, a fluorinated polyalkylene, a perfluoroalkoxyethylene, a polychlorotrifluoroethylene, a polyvinyldiene fluoride, a polysiloxane, a polyalkylene, a fluoro alkyl silane, a polyvinylfluoride, thermoplastic polymers such as acrylonitrile butadiene styrene (ABS) and polycarbonates (PC), thermosetting polymers, copolymers, terpolymers, a block copolymer, an alternating block copolymer, a random polymer, homopolymers, a random copolymer, a random block copolymer, a graft copolymer, a star block copolymer, a dendrimer, a poly electrolyte, a polyampholyte (a polyelectrolyte having both cationic and anionic repeat groups), an ionomer, parylene, silicone polymers, or a combination comprising at least one of the foregoing polymers, or (iv) a combination comprising at least one of the foregoing inorganic compounds, organic compounds, inorganic-organic compounds, and polymers.

In some examples, all surfaces of the drying cavity comprise the hydrophobic material.

In other examples, the hydrophobic material comprises a water contact angle of more than 90 degrees as tested by the ASTM D7490-13 standard.

In some instances, the hydrophobic material has a pencil hardness level of more than 3B as tested by ASTM D3363-05(2011)e2 standard.

In other examples, the hydrophobic material meets at least level three of durability in the pull-off test (tape test) as tested by the ASTM F2452-04-2012 standard.

In another aspect, a drying apparatus configured to receive at least some portion of a human hand within a drying cavity configured to remove liquid droplets from the received portion of the human hand comprises an inner wall surface comprising a hydrophobic material that remains 90 percent free of the liquid droplets after the drying operation. For example, the hydrophobic material comprises a textured layer comprising a plurality of individual surface features in a micro- or nano-structure size range and optionally a surface layer disposed on the textured layer.

In some examples, pull-off strength of the disposed surface layer in the absence of the textured layer is lower than in the presence of the textured layer.

In other examples, the surface layer comprises at least one repellent material.

In certain instances, the repellent material comprises one or more of a silicone polymer, a fluorinated polymer, an oligomeric siloxane, a silane or fluorine derivative, hydrophobic nanoparticles, and combinations thereof.

In some examples, each external surface of the drying apparatus comprises the textured layer. For example, each external surface of the drying apparatus comprises a surface layer disposed on the textured layer. In some examples, each internal surface of the drying apparatus comprises the surface layer. In other examples, a second textured layer disposed on the textured layer can be present. In certain examples, the surface layer is infused into pores of the textured layer, and wherein after addition of the surface layer a surface roughness of the article decreases compared to a surface roughness of the article before addition of the surface layer to the textured layer.

In some embodiments, the surface layer provides a pull-off strength at least 10% greater when the textured layer is present than a pull-off strength in the absence of the textured layer when pull-off strength is tested using ASTM D4541-09.

In certain embodiments, the surface layer provides a pull-off strength of at least 200 psi as tested by ASTM D4541-09.

In other examples, the surface layer comprises one or more of a silicone polymer, a fluorinated polymer, an oligomeric siloxane, hydrophobic nanoparticles, silane and fluorine derivatives, and combinations thereof.

In some configurations, an additional layer disposed on the surface layer may be present.

In certain examples, the drying apparatus may comprise a heater. In other examples, the drying apparatus may comprise a jet configured to provide a high pressure airstream to dry the received portion of the human hand.

In certain examples, each of the plurality of surface features comprises smaller features to provide a hierarchical structure in the textured layer. In some embodiments, the hydrophobic material is present in an elastic sheet applied on some portion of the drying cavity.

In some examples, the drying apparatus is configured as an air-knife hand dryer.

In another aspect, a drying apparatus configured to provide air to a portion of a human hand to remove liquid from the portion of the human hand is provided. For example, the drying apparatus can comprise an exterior surface comprising a textured layer disposed on the exterior surface, and a surface coating disposed on the textured layer. In some configurations, in the absence of the textured layer a pull-off strength of the surface coating is lower than in the presence of the textured layer when the pull-off strength is tested by ASTM D4541-09.

In some examples, the textured layer comprises a plurality of individual microstructures of an average characteristic length in the microscale or nanoscale size range. In other examples, the textured layer comprises metals, inorganic compounds, polymers, ceramics, nanocomposites (nanoparticles in a metallic or polymeric matrix).

In some embodiments, the textured layer is produced using a method selected from the group including but not limited to photolithography, projection lithography, e-beam writing or lithography, depositing nanowire arrays, growing nanostructures on the surface of a substrate, soft lithography, replica molding, solution deposition, solution polymerization, electropolymerization, electrospinning, electroplating (electrodeposition), electroless deposition, sol-gel deposition, vapor deposition, layer-by-layer deposition, rotary jet spinning of polymer nanofibers, contact printing, transfer patterning, microimprinting, self-assembly, boehmite (γ-AIO(OH)) formation, spray coated, spray coating, brush coating, electrophoretic deposition, reaction of fluorine gas, plasma deposition, plasma etching, chemical etching, grit blasting, ion milling, laser patterning or a combinations thereof.

In some examples, the textured layer is made by transferring the negative replica of a textured mold to the coating in a molding process. In other examples, the textured mold is made by electrodeposition, e-beam writing or lithography, laser patterning, chemical etching, plasma etching, ion milling, or combinations thereof.

In some configurations, a water contact angle of the surface coating is at least 80 degrees or at least 90 degrees as tested by ASTM D7490-13.

In other configurations, the textured layer comprises a first textured layer and a second textured layer.

In some examples, the surface coating comprises a repellent material comprising one or more of a silicone polymer, a fluorinated polymer, an oligomeric siloxane, hydrophobic nanoparticles, silane and fluorine derivatives, and combinations thereof.

In an additional aspect, a drying apparatus configured to provide air to a portion of a human hand to remove liquid from the portion of the human hand comprises an exterior surface comprising a textured layer disposed on some portion of the exterior surface, and a surface coating comprising a repellent material and disposed on the textured layer. For example, the repellent material can be disposed on the textured layer and infuses into space in the textured layer to partially or completely fill space between microstructures of the textured layer. In some examples, in the absence of the textured layer a pull-off strength of the surface coating is lower than in the presence of the textured layer when the pull-off strength is tested by ASTM D4541-09.

In some configurations, the textured layer comprises a plurality of individual microstructures of an average characteristic length positioned in different planes and in different heights with respect to a reference zero point in the textured layer. In some examples, the textured layer comprises metals, inorganic compounds, polymers, ceramics, nanocomposites (nanoparticles in a metallic or polymeric matrix).

In other examples, the repellent material comprises one or more of a silicone polymer, a fluorinated polymer, an oligomeric siloxane, hydrophobic nanoparticles, silane and fluorine derivatives, and combinations thereof. In further examples, the repellent material comprises a silicone polymer it comprises polydimethylsiloxane, wherein when the repellent material comprises a fluorinated polymer it comprises polytetrafluoroethylene, wherein when the repellent material comprises an oligomeric siloxane it comprises a fluorinated-base oligomeric siloxane, wherein when the repellent material comprises hydrophobic nanoparticles it comprises hydrophobic silica particles, alumina particles, or particles of molybdenum disulfide. In some embodiments, the textured layer comprises metals, inorganic compounds, polymers, ceramics, nanocomposites (nanoparticles in a metallic or polymeric matrix). For example, when the textured layer comprises metals it comprises nickel or stainless steel. When the textured layer comprises polymers it comprises acrylonitrile butadiene styrene (ABS), polycarbonates (PC), polytetrafluoroethylene, silicone polymers, or their combination. When the textured layer comprises nanocomposites it comprises nanoparticles including but not limited to PTFE particles, silica particles, alumina particles, silicon carbide, diatomaceous earth, boron nitride, titanium oxide, platinum oxide, diamond, particles formed from differential etching of spinodally decomposed glass, single wall carbon nanotubes, mix silicon/titanium oxide particles (TiO2/SiO2, titanium inner core/silicon outer surface), ceramic particles, thermo-chromic metal oxide, multi-wall carbon nanotubes, kaolin (Al2O3.2SiO2.2H2O), any chemically or physically modified versions of the foregoing particles in a metallic or polymeric matrix.

In some examples, the textured layer comprises a first textured layer and a second textured layer. In other examples, the first textured layer comprises different shaped microstructures than the second textured layer.

Additional aspects, features, examples, embodiments and configurations are described in more detail below.

### BRIEF DESCRIPTION OF THE FIGURES

Certain configurations of drying apparatus are described below with reference to the accompanying figures in which:

FIG. 1 is an illustration of a drying apparatus, in accordance with certain examples;

FIG. 2 is another illustration of a drying apparatus, in accordance with certain configurations;

FIGS. 3A, 3B and 3C are illustrations of a hand dryer, in accordance with certain examples;

FIGS. 4A, 4B and 4C are another illustration of a hand dryer, in accordance with certain configurations;

FIGS. 5A, 5B and 5C are additional illustrations of a hand dryer, in accordance with certain examples;

FIG. 6 is an illustration of an electrodeposition apparatus, in accordance with certain examples; and

FIG. 7 is an illustration of a drying apparatus surface comprising a textured layer and a surface coating, in accordance with certain configurations.

It will be recognized by the person of ordinary skill in the art, given the benefit of this disclosure, that the relative dimensions in the figures are shown for illustration purposes only. The exact shape, length, width, etc. of the various drying apparatus may vary from configuration to configuration.

### DETAILED DESCRIPTION

Certain configurations described below relate to a drying apparatus, such as a hand dryer, that includes a drying cavity in which a wet object, such as wet hands, can be accommodated. The drying cavity includes an opening and at least one inner wall surface. A wet object is inserted into the opening and a high pressure airstream is used to dry the object.

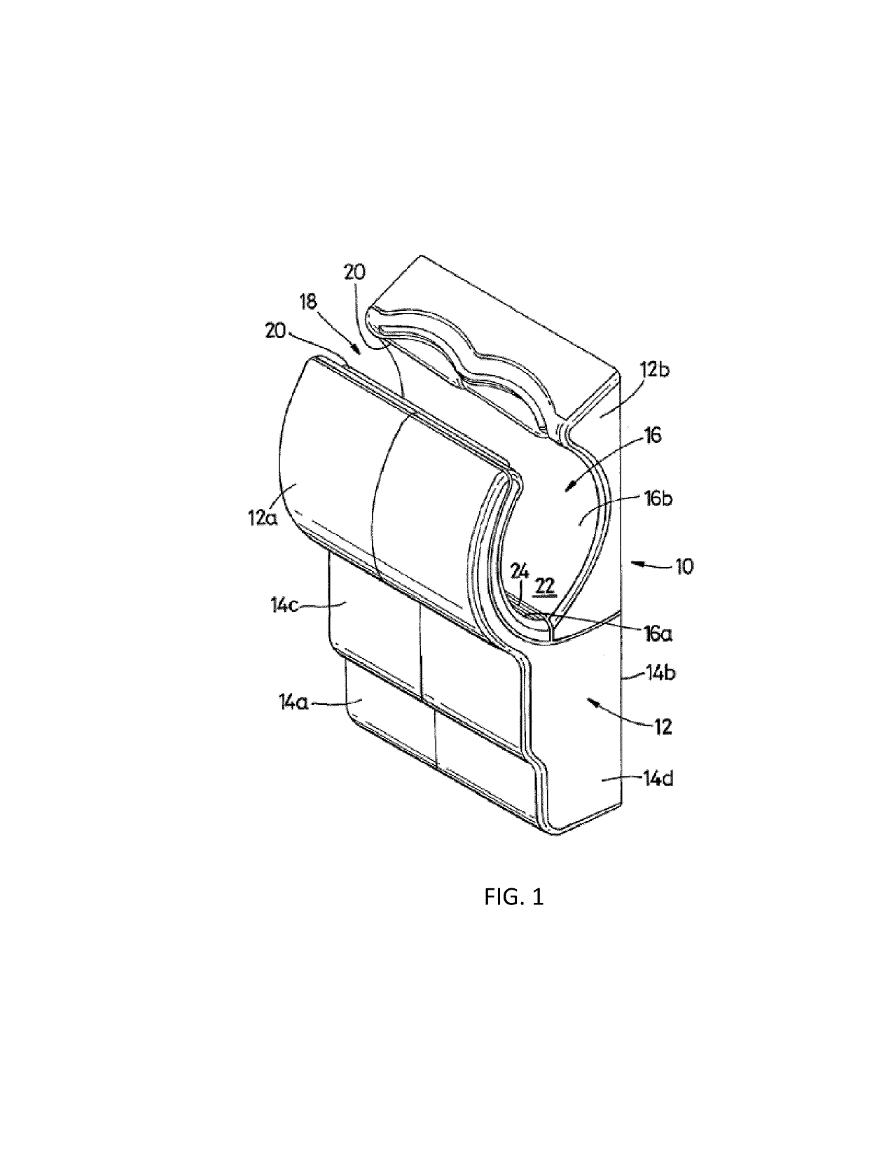

One non-limiting illustration of a drying apparatus is shown in FIG. 1. In this example, the drying apparatus is configured as a hand dryer. The hand dryer 10 comprises an outer case 12 which comprises a front portion 12a and a rear portion 12b. The hand dryer 10 further comprises a front wall 14a, a rear wall 14b, two side walls 14c and 14d, and a cavity 16. The rear portion 12b of the outer case 12 may include elements suitable for attaching the hand dryer 10 to a surface, wall or other suitable fixture. Further, the hand dyer 10 can be mounted in many different orientations relative to gravity. Elements for connecting the hand dryer 10 to a power source, e.g., an electrical outlet, generator, battery, fuel cell, solar cell, wind turbine, etc. may also be included. In this illustration, the cavity 16 is defined by two opposing inner walls, front wall 16a and rear wall 16b. The cavity 16 is open at its upper end 18, and the dimensions of the opening are sufficient to allow human hands (not shown) to be inserted easily into the cavity 16 for drying. The cavity 16 is also open at the sides, though the sides could be closed if desired. A high-speed airflow is generated by a motor unit having a fan (not shown) and is expelled through an opening 20, e.g., laminar vents, disposed at the upper end of the cavity 16 to dry the inserted hands. The opening 20 may be coupled to a jet or other nozzle to provide a high flow airstream through the opening 20. For example, an air flow exceeding 100 miles per hour, exceeding 200 miles per hour, exceeding 300 miles per hour or even exceeding 400 miles per hour can be provided through the opening 20 to dry the object inserted into the cavity 16.

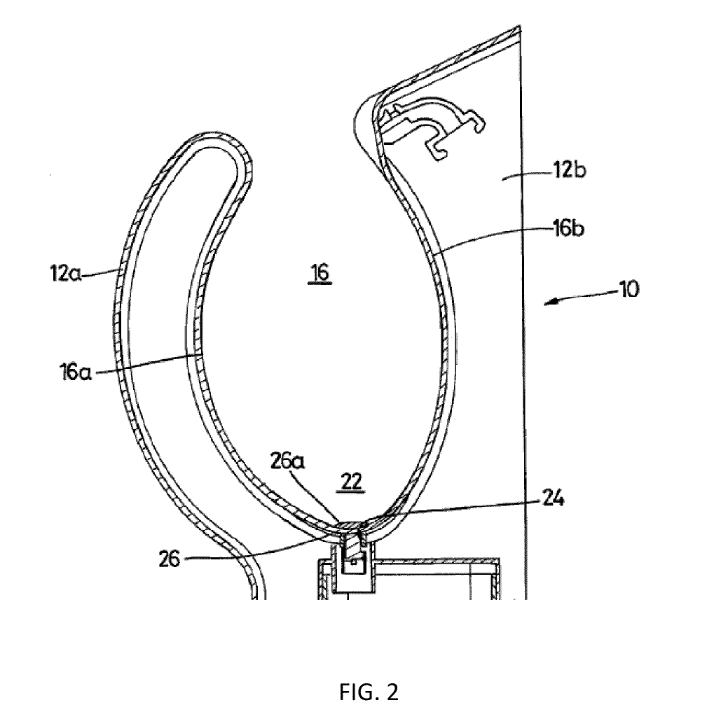

In some examples, the drying apparatus can be equipped with an arrangement for collecting waste water. In one configuration, the hand dryer 10 shown in FIGS. 1 and 2 is equipped with a drain channel 24 located at the lower end 22 of the cavity 16. The drain channel 24 is delimited by the lower edges of the front wall 16a and the rear wall 16b of the cavity 16. An outlet 26 can be located at one end of the drain channel 24. The drain channel 24 can be sloped or angled and the outlet 26 can be located at the lowest point of the drain channel 24. In some examples, the outlet 26 comprises a circular aperture with a central plug 26a, though different geometrical shapes can be used if desired. The plug 26a and outlet 26 delimit a narrow, annular portion of the outlet 26 down which water is able to flow.

In some configurations, the drying apparatus can also be equipped with an arrangement for removing waste water. The conventional arrangement is the manual removal of the waste water from a container located at the lower section of case 12. The waste water is transferred via a duct or similar structure to this container. Alternatively, the waste water may evaporate (or otherwise be removed) from this container using a thermal source, a piezo-electric device, or a similar arrangement. The container may be manually removed to empty the collected water, or the container can be coupled to a drain line or other similar fluid line to permit automatic draining of the collected water to a grey water collection system, e.g., a sewer system or grey water tank.

In use of the hand drying apparatus water splashes to (or contacts) the inner wall surfaces of the drying cavity. Existing drying apparatus are not equipped with a mechanism to completely remove the waste water from the drying cavity. Some of this waste water may get collected by the waste-water collecting mechanism explained before. However, a part of the waste water can remain on or in the drying cavity in the form of water droplets attached to the inner wall surfaces of the cavity. As an instance in the hand dryer shown in FIG. 1, water droplets stick to the front wall 16a and rear wall 16b of cavity 16. Therefore, in the regular use condition, the inner wall surfaces of the drying cavity are almost always wet. The wet cavity is non-hygienic, may lead to the growth and/or spread of bacteria and requires regular cleaning and sanitizing. This problem is particularly encountered in hand dryers located in public restrooms. In some configurations as noted in more detail below, a drying cavity with stay-dry surfaces that provides more hygienic conditions for the drying process compared to the existing drying apparatus may comprise one or more superhydrophobic coatings. For example, using superhydrophobic coatings/surfaces on or as some parts of the inner wall surfaces of the drying cavity can provide a more hygienic hand drying apparatus. In some examples, the superhydrophobic surfaces can be in the form of elastic sheets or coatings attached or applied on some parts of the inner wall surfaces of the drying cavity. In addition, some parts of the existing inner wall surfaces can be transformed to a superhydrophobic material by such techniques as laser-patterning or by depositing or coating a superhydrophobic material onto some portion of the drying apparatus.

In some examples, water droplets bead up on the superhydrophobic surfaces and roll off the surfaces with a slight applied force. The existing air flow in hand dryers exerts enough force to completely remove water droplets from the superhydrophobic surfaces. Moreover, dirt particles on superhydrophobic surfaces are picked up by the rolling droplets. Therefore, the coatings described herein can be used to provide a hygienic drying apparatus with both self-cleaning and self-drying properties. The drying apparatus can also be equipped with aforementioned arrangements for collecting and removing waste water.

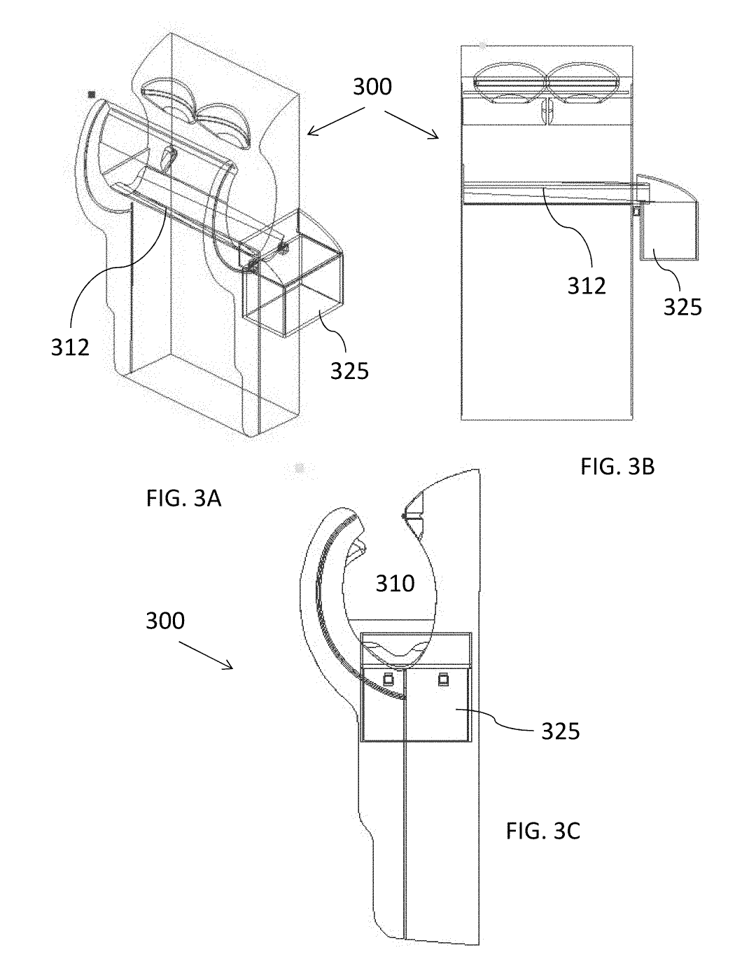

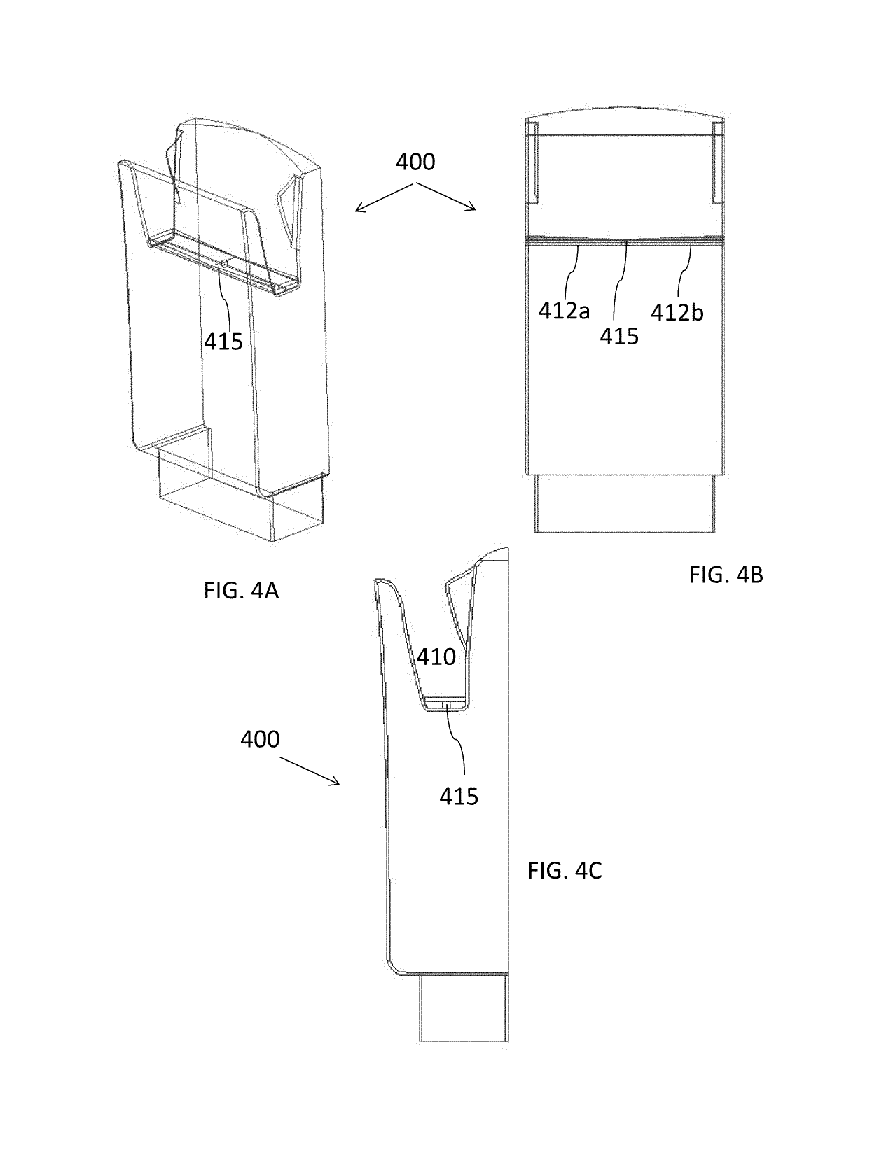

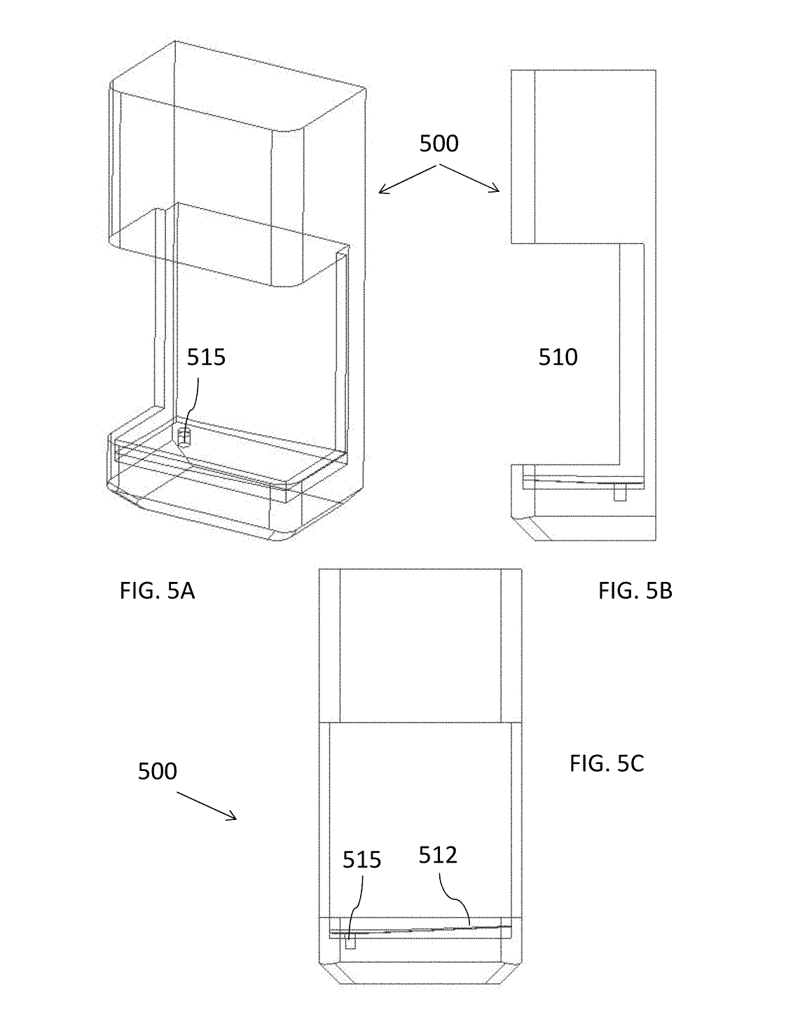

Without the desire to be constrained to a particular design, FIGS. 3, 3B and 3C show three views of a hand-dryer 300 with a hydrophobic drying chamber 310. The bottom surface 312 of the drying chamber 310 in this design is a tilted or angled toward a waste water container 325. Water droplets roll down on the hydrophobic surface of the bottom surface and get collected into the container 325 for a future drainage. FIGS. 4A-4C and FIGS. 5A-5C show two more designs for the disclosed hand-dryer. In these designs, waste water gets collected through a plug. The bottom surfaces of the drying cavities in both designs are tilted toward the plugs. Again, water droplets roll down on the tilted hydrophobic surface and get collected by the plug. Referring to FIGS. 4A, 4B and 4C, a hand dyer 400 comprises a drying cavity 419 with bottom surfaces 412a, 412b which are angled centrally toward a plug 415. Referring to FIGS. 5A, 5B and 5C, a hand dyer 500 comprises a drying cavity 510 with a bottom surface 512 which angles toward a drain plug 515 positioned at one side of the dryer 500.

In some examples, a hand dryer comprising a superhydrophobic surface comprises a surface layer, textured layer and/or combinations thereof on at least one region. Any one or more of the layers or coatings may comprise a plurality of microscale and/or nanoscale features. The layers or coatings ca be produced using numerous methods including, but not limited to, photolithography, projection lithography, e-beam writing or lithography, depositing nanowire arrays, growing nanostructures on the surface of a substrate, soft lithography, replica molding, solution deposition, solution polymerization, electropolymerization, electrospinning, electroplating (electrodeposition), electroless deposition, sol-gel deposition, vapor deposition, layered deposition, rotary jet spinning of polymer nanofibers, contact printing, etching, transfer patterning, microimprinting, self-assembly, boehmite (γ-AIO(OH)) formation, spray coated, spray coating, brush coating, electrophoretic deposition, reaction of fluorine gas, plasma deposition, etching, grit blasting, ion milling, laser-patterning or a combinations thereof. These techniques can be applied in combination with heating, cooling, vacuum conditioning, aging, exposure to electromagnetic radiation such as visible light, UV, and x-ray, or other processes. As noted in more detail below, superhydrophobic surfaces can be produced from the same material as the casing of the drying apparatus or they can be made from a different material. Any polymer, ceramic, poly-ceramic, metal or their combinations thereof can be used for providing superhydrophobic surfaces. As a non-limiting example superhydrophobic surfaces can be produced using thermoplastic polymers such as acrylonitrile butadiene styrene (ABS), polycarbonates (PC) or their combination. If desired, thermosetting polymers may also be used.

In certain configurations, one or more surfaces of a hand drying apparatus may comprise a coating comprising at least one textured layer. For example, one or more surfaces of the hand drying apparatus may comprise one or more coatings which may comprise various features. In some instances, the coating may comprise at least one textured layer comprising a metal or metallic compound. In certain configurations, the textured layer provides a hydrophobic surface comprising a plurality of surface features in the micro or nano size range. The size of the surface features is defined based on their largest characteristic length. Some textured layers comprise surface features in the range of 5 to 15 micrometer. Others comprise surface features in the range of 0.5 to 1 micrometer. In some examples, the surface features are positioned within at least at two different surface planes with different heights in regard to an arbitrary zero reference point. In other instances, the features can be packed closely together with negligible or substantially no space or no space between adjacent features compared to the overall size of the features. In certain examples, the coating of the hand dryer may comprise at least one textured layer with one or more of the following characteristics with respect to the arrangement of the surface features, composition, and hydrophobic characteristic of the textured layer. In some examples, the textured layer present on one or more surfaces of the hand drying apparatus may comprises a plurality of surface features in the range of 5 to 15 micrometer. The exact shape of the surface features may vary from spherical to other shapes. For example, the largest diameters of these spheres are defined as the size of the surface features. The surface features of the textured layer are desirably positioned at least at two different surface planes with different heights in regard to an arbitrary zero point. While not wishing to be bound by this example, there can be negligible space between adjacent features of the coating compared to the size of the features.

In some examples, the textured layers of the hand dryer surface coatings can be produced from different materials and different processes have been used for their manufacturing. For example, all layers may comprise a plurality of surface features in the micro or nano size range. Surface features of some of the textured layers can resemble regular geometries. Mass of regular geometries is directly proportional to their characteristic dimension raised to an integer power (e.g. a third power for a sphere). However, the size of the spheres, the size distribution of the spherical features, and the small constituents comprising the spherical shapes can be different for each surface texture. If desired, some of the textured layers may comprise surface features with irregular geometries. The mass of these irregular geometries is proportional to their characteristic dimension raised to a fractional power. The irregular surface features of different textured layers have different shapes and sizes. In some examples, the surface features of a textured layer comprise smooth planes each facing to a specific direction. The other textured layers all comprise non-faceted surface features and the constituents of their surface features do not represent specific direction.

In certain examples, the textured layers described herein may comprise at least one metal or metallic compound. Examples of some of the metals which can be used include, but are not limited, to Nickel (Ni), Zinc (Zn), Chromium (Cr), Copper (Cu), Zinc/Nickel alloy (Zn/Ni), Zinc/Copper alloy (Zn/Cu), and other transition metals and combinations thereof. Examples of metallic compounds include, but are not limited to, metal oxides, metal carbides, metal nitrides, metal hydroxides, metal carbonitrides, metal oxynitrides, metal borides, metal borocarbides, metal fluorides, other metal compounds, or any combination thereof. Energy-dispersive (EDS) X-ray spectroscopy or any other analytical techniques can be used to show the presence of metal or metallic compound in the textured layer. EDS measures the number and energy of the X-rays emitted from a specimen. This energy is the characteristic of different species in that specimen. Therefore, EDS allows the elemental composition of the specimen to be measured.

In certain configurations, the textured layers described herein may provide hydrophobic characteristics without any additional chemical treatment. If desired, however, certain physical treatments may be performed to make the textured layer hydrophobic or render it more hydrophobic. For example, a water contact angle of greater than 90° is desirably provided using the coatings described herein. In addition, a superhydrophobic coating is defined as a coating which provides a water contact angle of more than 150°. Water contact angle can be measured using contact angle measurement equipment based on the ASTM D7490-13 standard. This angle is conventionally measured through the droplet, where the water-air interface meets the solid surface. A Kruss-582 system can be used to obtain the contact angle data. In certain examples, the exact properties of the coatings described herein may vary depending on the materials present and the methods used to produce the coatings.

Without wishing to be bound by any particular theory, the effect of texture on the hydrophobic properties of a hand drying apparatus surface can be explained, for example, in the following illustration. Air can becomes trapped in void spaces between microscale and nanoscale structures of the surface coating and protects the surface against wetting. Since air is an absolute hydrophobic material, this air trapping results in enhancing the hydrophobic property of the surface and a large contact angle (θ₁) is formed. This behavior can be compared with the interaction of a water droplet with a non-textured surface where the water droplet completely wets the surface. Moreover, on the non-textured surface a smaller contact angle is typically present. By using the materials and processes described herein, packing of micro- and nano-structures together to trap air between the tightly packed structures can further enhance hydrophobicity of the hand dryer surface coatings.

In another embodiment, a process for providing a coating on one more surfaces of a hand drying apparatus may comprise one or more electrodeposition techniques. For example, one or more external surfaces, panels or the components of the hand drying apparatus, prior to assembly, may be subjected to an electrodeposition technique to provide a superhydrophobic coating. The electrodeposition technique desirably provides the formation of a textured layer which comprises some or all of the characteristics or features described herein, e.g., is hydrophobic and/or comprises a large water contact angle. In one non-limiting illustration, an electrodeposition method may include providing an electrolyte mixture. Possible compositions of this mixture are discussed below; the surface of the hand drying apparatus can be cleaned or activated and then placed in the electrolyte mixture. An anode can be used to deposit the coating on the hand drying apparatus surface. This disclosure is not bound by the type of the surface material or the method of the cleaning or activation process. Further information about the surface is provided later in this disclosure. Different cleaning processes including but not limited to pickling, acid wash, saponification, vapor degreasing, and alkaline wash may be used for cleaning the surface. The activation process may include but not limited to removal of the inactivate oxides by acid wash or pickling and catalytic deposition of a seed layer; providing an anode. This disclosure is again not limited on the shape and material of the anode. Further information about the anode is provided below; if desired, depositing optional intermediate layers can be performed followed by depositing one or more textured layers by applying process conditions in the bath. Illustrative ranges of these conditions will be discussed below. The substrate can be removed from the bath, and optional additional processes can be performed—these processes may include different physical or chemical treatments as noted in more detail below.

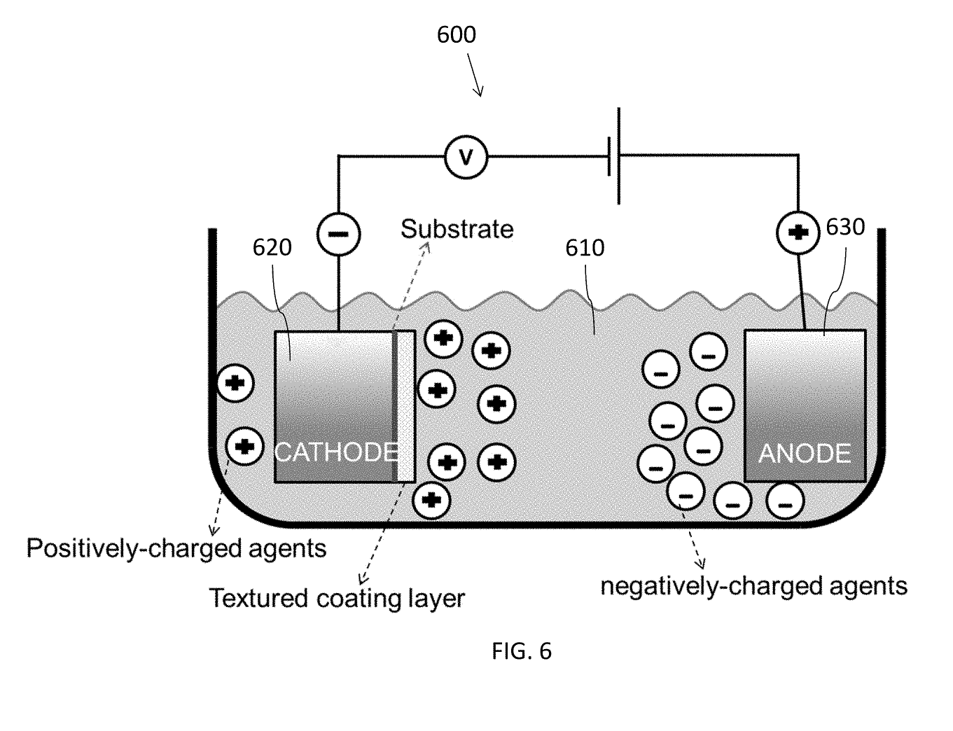

In certain examples, a typical electrodeposition device/system is shown in FIG. 6. The system 600 comprises three main components: an electrolyte 610, a negative electrode or cathode 620, and a positive electrode or anode 630. A substrate can be a part of the cathode 620. Both the cathode 620 and anode 630 can be placed in the electrolyte mixture 610. When electricity is applied, the substrate becomes negatively-charged and attracts positively-charged agents in the solution 610. A constant, multistep or varying voltage or current can be applied in the electroplating process to control or enhance the resulting coating properties. As a result of applying electricity, positively-charged agents are reduced or neutralized on the substrate and provide the textured layer. As a non-limiting example, a constant voltage in the range of −1 V to −10 V can be applied. As another non-limiting example a constant current in the range of −0.01 to −0.1 mA/cm² can be applied. The other non-limiting example is applying a varying voltage that alternates or swipes between the open circuit potential and a high voltage beyond the initiation of gas formation during the electrodeposition process. The electrolyte 310 is an aqueous mixture of different components. At least one of these components can be a positively-charged agent that is reduced by applying a voltage or current and gets deposited on the negative electrode. This deposit forms, at least in part, the textured layer. Other components of the electrolyte 310 may also get entrapped in the structure of the textured layer during the electrodeposition process. The electrodeposition process may be performed at a temperature ranging from 25 to 95° C. Moreover, the electrodeposition may be performed under non-agitation or agitation condition with the agitation rate of 0 to 800 rpm.

In addition to positively-charged agents, electrolyte mixture 610 may comprise other compounds including, but not limited to, ionic compounds such as negatively-charged agents to enhance electrolyte conductivity, buffer compounds to stabilize electrolyte pH, and different additives. Examples of natively-charged agents, include but are not limited to, bromide (Br⁻), carbonate (CO₃⁻), hydrogen carbonate (HCO₃⁻), chlorate (ClO₃⁻), chromate (CrO₄⁻), cyanide (CN⁻), dichromate (Cr₂O₇²⁻), dihydrogenphosphate (H₂PO₄⁻), fluoride (F⁻), hydride (H⁻), hydrogen phosphate (HPO₄²⁻), hydrogen sulfate or bisulfate (HSO₄⁻), hydroxide (OH⁻), iodide (I⁻), nitride (N³⁻), nitrate (NO₃⁻), nitrite (NO₂⁻), oxide (O₂⁻), permanganate (MnO₄⁻), peroxide (O₂²⁻), phosphate (PO₄³⁻), sulfide (S²⁻), thiocyanate (SCN⁻), sulfite (SO₃²⁻), sulfate (SO₄²⁻), chloride (Cl⁻), boride (B³⁻), borate (BO₃³⁻), disulfide (S₂²⁻), phosphanide (PH₂⁻), phosphanediide (PH²⁻), superoxide (O₂⁻), ozonide (O₃⁻), triiodide (I₃⁻), dichloride (Cl₂⁻), dicarbide (C₂²⁻), azide (N₃⁻), pentastannide (Sn₅²⁻), nonaplumbide (Pb₉⁴⁻), azanide or dihydridonitrate (NH₂⁻), germanide (GeH₃⁻), sulfanide (HS⁻), sulfanuide (H₂S⁻), hypochlorite (ClO⁻), hexafluoridophosphate ([PF₆]⁻), tetrachloridocuprate(II) ([CuCl₄]²⁻), tetracarbonylferrate ([Fe(CO)₄]²⁻), hydrogen(nonadecaoxidohexamolybdate) (HMo₆O₁₉⁻), tetrafluoroborate ([BF₄⁻]), Bis(trifluoromethylsulfonyl)imide ([NTf₂]⁻), trifluoromethanesulfonate ([TfO]⁻), Dicyanamide [N(CN)₂]⁻, methylsulfate [MeSO₄]⁻, dimethylphosphate [Me₂PO₄]⁻, acetate [MeCO₂]⁻, other similar groups, or any combination thereof.

In addition to the positively- and negatively charged agents, the electrolyte mixture 610 can also comprise one or several additives. Illustrative examples of additives, include are but not limited to, thiourea, acetone, ethanol, cadmium ion, chloride ion, stearic acid, ethylenediamine dihydrochloride, saccharin, cetyltrimethylammonium bromide (CTAB), sodium dodecyl sulfate, ethyl vanillin, ammonia, ethylene diamine, polyethylene glycol (PEG), bis(3-sulfopropyl)disulfide (SPS), Janus green B (JGB), azobenzene-based surfactant (AZTAB), the polyoxyethylene family of surface active agents, sodium citrate, perfluorinated alkylsulfate, additive K, calcium chloride, ammonium chloride, potassium chloride, boric acid, myristic acid, choline chloride, citric acid, any redox active surfactant, any conductive ionic liquids, any wetting agents, any leveling agent, any defoaming agent, any emulsifying agent or any combination thereof. Examples of wetting agents include, but are not limited, to polyglycol ethers, polyglycol alcohols, sulfonated oleic acid derivatives, sulfate form of primary alcohols, alkylsulfonates, alkylsulfates aralkylsulfonates, sulfates, Perfluoro-alkylsulfonates, acid alkyl and aralkyl-phosphoric acid esters, alkylpolyglycol ether, alkylpolyglycol phosphoric acid esters or their salts, or any combination thereof. Examples of leveling agents include but not limited to N-containing and optionally substituted and/or quaternized polymers, such as polyethylene imine and its derivatives, polyglycine, poly(allylamine), polyaniline (sulfonated), polyvinylpyrrolidone, polyvinylpyridine, polyvinylimidazole, polyurea, polyacrylamide, poly(melamine-co-formaldehyde), polyalkanolamines, polyaminoamide and derivatives thereof, polyalkanolamine and derivatives thereof, polyethylene imine and derivatives thereof, quaternized polyethylene imine, poly(allylamine), polyaniline, polyurea, polyacrylamide, poly(melamine-co-formaldehyde), reaction products of amines with epichlorohydrin, reaction products of an amine, epichlorohydrin, and polyalkylene oxide, reaction products of an amine with a polyepoxide, polyvinylpyridine, polyvinylimidazole, polyvinylpyrrolidone, or copolymers thereof, nigrosines, pentamethyl-para-rosaniline, or any combination thereof. Examples of defoaming agents include but not limited to fats, oils, long chained alcohols or glycols, alkylphosphates, metal soaps, special silicone defoamers, commercial perfluoroalkyl-modified hydrocarbon defoamers and perfluoroalkyl-substituted silicones, fully fluorinated alkylphosphonates, perfluoroalkyl-substituted phosphoric acid esters, or any combination thereof. Examples of emulsifying agents include but not limited to cationic-based agents such as the alkyl tertiary heterocyclic amines and alkyl imadazolinium salts, amphoteric-based agents such as the alkyl imidazoline carboxylates, and nonionic-based agents such as the aliphatic alcohol ethylene oxide condensates, sorbitan alkyl ester ethylene oxide condensates, and alkyl phenol ethylene oxide condensates.

In some instances, the electrolyte mixture 610 may also comprise a pH adjusting agent selected from a group including but not limited to inorganic acids, ammonium bases, phosphonium bases, or any combination thereof. The pH of the electrolyte mixture can be adjusted to a value within the range of 3 to 10 using these pH adjusting agents. The electrolyte can also include nanoparticles that can get entrapped in the textured layer. Examples of nanoparticles include but not limited to PTFE particles, silica (SiO₂) particles, alumina particles (Al₂O₃), silicon carbide (SiC), diatomaceous earth (DE), boron nitride (BN), titanium oxide (TiO₂), diamond, particles formed from differential etching of spinodally decomposed glass, single wall carbon nanotubes (SWCNTs), multi-wall carbon nanotubes (MWCNTs), platinum oxide (PtO₂), other nanoparticles, any chemically or physically modified versions of the foregoing particles, or any combination thereof.

As a non-limiting example, a textured copper layer can be electrodeposited from an aqueous solution comprising Cu²⁺, SO₄²⁻, H⁺, other charged agents, or additives. As another non-limiting example, a textured zinc layer can be electrodeposited from an aqueous solution comprising Zn²⁺, Cl⁻, BO₃³⁻, H⁺, K⁺, other charged agents, or additives.

In certain examples, the substrate or the base article of the coating can be a part of cathode 620. In FIG. 6, the substrate is schematically depicted as a flat plate; however, it can have different shapes. As an instance, the substrate can be a part of a tube or an object with any regular or irregular geometry. The substrate can be made of any material that can get electroplated including metals, alloys, plastics, composites, and ceramics. An intermediate layer can be applied between the substrate and the electrodeposited coating. The substrate can be conductive or non-conductive. However, for non-conductive substrates an intermediate activation layer or seed layer may be applied before the electrodeposition process. In addition, different surfaces of the hand drying apparatus may comprise different textured layers if desired.

In some embodiments, in a two-electrode electrodeposition process, such as that depicted in FIG. 6, the anode 630 is the reference of the voltage. It is also possible to provide a third electrode as a voltage reference. In FIG. 6, the anode 630 is schematically depicted as a flat plate; however, it can have different shapes. As an instance, it can be in the shape of pallets, mesh, bar, cylinder or it can be a part of an object with any regular or irregular geometry. The anode 630 can gradually dissolve during the electrodeposition process and contribute in replenishing the positively charged-ions in the electrolyte. As a non-limiting example, zinc and nickel plates can be used in the zinc and nickel electrodeposition process, respectively. Some anodes such as those made of platinum or titanium remain intact during the electrodeposition process.

In certain examples and while not wishing to be bound by any particular theory, the formation of the surface textures by electrodeposition can be understood from the following non-limiting explanation The electroplating process is based on a nucleation and growth mechanism. Non-homogeneous conditions during the nucleation and growth process can result in the formation of textures on the surface of the growing material layer. When the conditions of the growth are not homogeneous, different locations of the surface encounter different growth rates. Some locations grow faster and form peaks while others grow slower and become valleys. This presence of these different resulting features provide for a surface texture on the substrate. In electroplating, different parameters such as voltage, bath composition, agitation, and bath temperature can be adjusted to control the level of non-homogeneity in the nucleation and growth process, and therefore, make different surface textures. In some instances, the electroplating conditions can be altered during surface coating formation to promote the formation of the textures surfaces. The effects of the process parameters on the deposit surface texture can be better understood by the following non-limiting explanation on the effects of voltage and bath composition. In some examples, the applied voltage can be controlled or tuned during coating to promote formation of textured surfaces. The effect of the applied voltage can be explained by unstable growth theories such as Mullins-Sekerka instability model (see, for example, Mullins and Sekerka, Journal of Applied Physics, Volume 35, Issue 2 (2004). Based on these theories, diffusional mass transfer favors the growth of the arbitrary protrusions of the surface and enhances the morphological instabilities or texture of the growing surface. By controlling the applied voltage, desired growth rates and effects for the surface textures can be achieved.

In certain configurations, similar to the applied voltage, the concentration of different species of the electrolyte mixture 610 can also affect the level of diffusional mass transfer in the bath and, therefore, can have an effect on the deposited surface textures. In addition to this effect, bath composition can have other interesting effects on the deposit surface texture, which is called the additive effect. The additive effect refers to the effect of a chemical reagent on making non-homogeneous growth conditions and subsequently forming a surface texture. Different chemical reagents undergo different mechanisms to promote the non-homogeneous growth condition. For example, additive reagent can restrict crystal growth in specific directions and results in a non-homogeneous growth process and texture formation. For instance, an additive can restrict the growth process in the horizontal direction and results in the formation of conical structures. This type of additive reagents is called a crystal modifier. Crystal modifiers kinetically control the growth rates of different crystalline faces of metal particles by interacting with these faces through adsorption and desorption. Coordinating reagents are another group of additives that can promote non-homogeneous growth conditions and form surface textures. These additives form complexes with some of the metal ions. The other ions remain free in the solution. The presence of two different types of metal ions (free ions and ions involved in complexation) results in a non-homogeneous growth condition and can promote texture formation.

In certain examples, the exact attributes and properties of the coatings on the hand dryer surfaces described herein can vary depending on the particular materials which are present, the coating conditions used, etc. In some examples, the surface features of the textured layer of the coatings may exhibit a hierarchical structure. Hierarchical structure refers to the condition where each surface feature comprises smaller features. For example, the size of surface features in hierarchical structures can desirably be at least two times larger than their constituent features. As a prophetic example, the first feature size might be 10 microns while the second feature size is 1 micron.

In certain instances, the textured layer present on one or more surfaces of the hand drying apparatus can comprise a composite of metals or metallic compound and nanoparticles. Nanoparticles can be selected from the group consisting of PTFE particles, silica (SiO₂) particles, alumina particles (Al₂O₃), silicon carbide (SiC), diatomaceous earth (DE), boron nitride (BN), titanium oxide (TiO₂), platinum oxide (PtO₂), diamond, particles formed from differential etching of spinodally decomposed glass, single wall carbon nanotubes (SWCNTs), mix silicon/titanium oxide particles (TiO₂/SiO₂, titanium inner core/silicon outer surface), ceramic particles, thermo-chromic metal oxide, multi-wall carbon nanotubes (MWCNTs), any chemically or physically modified versions of the foregoing particles, and any combination thereof.

In certain configurations, in addition to the textured layer, the coating can comprise other layers as well. Each coating layer can be distinguished from its top and underneath layers by its different composition. Two adjacent layers might have distinct or indistinct interfaces. Two examples of multiple-layer coatings are discussed below. In a first example, the condition wherein one or multiple conformal coating layers are present on top of the textured layer is described. Conformal layers are defined as the coating layers that approximately follow the surface texture of their underneath layer. The conformal coating layer can comprise one or more of Chromium Nitride (CrN), Diamond Like Carbon (DLC), Titanium Nitride (TiN), Titanium Carbo-nitride (TiCN), Aluminum Titanium Nitride (ALTiN), Aluminum Titanium Chromium Nitride (AlTiCrN), Zirconium Nitride (ZrN), Nickel, gold, PlasmaPlus®, Cerablack™, Chromium, Nickel Fluoride (NiF₂), any Nickel Composite, any organic or inorganic-organic material and combinations thereof. Examples of nickel composites suitable for use as the conformal coating include, but are not limited to, composites of nickel with different particles selected from a group consisting of PTFE, silica (SiO₂), alumina (Al₂O₃), silicon carbide (SiC), diamond, diatomaceous earth (DE), boron nitride (BN), titanium oxide (TiO2), single wall carbon nanotubes (SWCNTs), multi-wall carbon nanotubes (MWCNTs), kaoline (Al₂O₃.2SiO₂.2H₂O), graphite, other nanoparticles, or any combination thereof. Examples of organic or inorganic-organic materials suitable for use as the conformal coating include, but are not limited to, parylene, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, silicone polymers, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), other similar groups, or any combination thereof.

In some instances, organofunctional silanes are a group of compounds that combine the functionality of a reactive organic group with inorganic functionality in a single molecule. This special property allows them to be used as molecular bridges between organic polymers and inorganic materials. The organic moiety of the silane system can be tailored with different functionalities consisting amino, benzylamino, benzyl, chloro, fluorinated alkyl/aryl, disulfido, epoxy, epoxy/melamine, mercapto, methacrylate, tetrasulfido, ureido, vinyl, vinyl-benzyl-amino, and any combination thereof. While any of these groups can be used application of the following groups is more common: amino, chloro, fluorinated alkyl/aryl, vinyl, and vinyl-benzyl-amino. The examples of aminosilane system are n-(3-acryloxy-2-hydroxypropyl)-3-aminopropyltriethoxysilane, n-(n-acetylleucyl)-3-aminopropyltriethoxysilane, 3-(n-allylamino)propyltrimethoxysilane, 4-aminobutyltriethoxysilane, 4-amino-3,3-dimethylbutylmethyldimethoxysilane, 4-amino-3,3-dimethylbutyltrimethoxysilane, aminoneohexyltrimethoxysilane, 1-amino-2-(dimethylethoxysilyl)propane, n-(2-aminoethyl)-3-aminoisobutyldimethylmethoxysilane, n-(2-aminoethyl)-3-aminoisobutylmethyldimethoxysilane, (aminoethylaminomethyl)phenethyltrimethoxysilane, n-(2-aminoethyl)-3-aminopropylmethyldiethoxysilane, n-(2-aminoethyl)-3-aminopropylmethyldimethoxysilane, n-(2-aminoethyl)-3-aminopropyltrimethoxysilane-propyltrimethoxysilane, oligomeric co-hydrolysate, n-(2-aminoethyl)-2,2,4-trimethyl-1-aza-2-silacyclopentane, n-(6-aminohexyl)aminomethyltriethoxysilane, n-(2-aminoethyl)-11-aminoundecyltrimethoxysilane, 3-(m-aminophenoxy)propyltrimethoxysilane, m-aminophenyltrimethoxysilane, p-aminophenyltrimethoxysilane, aminophenyltrimethoxysilane, n-3-[(amino(polypropylenoxy)]aminopropyltrimethoxysilane, 3-aminopropyldiisopropylethoxysilane, 3-aminopropyldiisopropylethoxysilane, 3-aminopropyldimethylethoxysilane, 3-aminopropyldimethylfluorosila, n-(3-aminopropyldimethylsilyl)aza-2,2-dimethyl-2-silacyclopentane, 3-aminopropylmethyldiethoxysilane, 3-aminopropyltris(methoxyethoxyethoxy)silane, 11-aminoundecyltriethoxysilane, n-(2-n-benzylaminoethyl)-3-aminopropyltrimethoxysilane, n,n-bis(2-hydroxyethyl)-3-aminopropyltriethoxysilane, bis(trimethylsilyl)-3-aminopropyltrimethoxysilane, n-butylaminopropyltrimethoxysilane, t-butylaminopropyltrimethoxysilane, (n-cyclohexylaminomethyl) methyldiethoxysilane, (n-cyclohexylaminopropyl) trimethoxysilane, (n,n-diethylaminomethyl)triethoxysilane, (n,n-diethyl-3-aminopropyl)trimethoxysilane, 3-(n,n-dimethylaminopropyl)aminopropylmethyldimethoxysilane, (n,n-dimethylaminopropyl)-aza-2-methyl-2-methoxysilacyclopentane, n,n-dimethyl-3-aminopropylmethyldimethoxysilane, 3-(1,3-dimethylbutylidene)aminopropyltriethoxysilane, (3-(n-ethylamino)isobutyl)methyldiethoxysilane, (3-(n-ethylamino)isobutyl)trimethoxysilane, n-methyl-n-trimethylsilyl-3-aminopropyltrimethoxysilane, (phenylaminomethyl)methyldimethoxysilane, n-phenylaminomethyltriethoxysilane, n-phenylaminopropyltrimethoxysilane, 3-(n-styrylmethyl-2-aminoethylamino)propyltrimethoxysilane hydrochloride, (3-trimethoxysilylpropyl)diethylenetriamine, (cyclohexylaminomethyl)triethoxy-silane, (n-methylaminopropyl)methyl(1,2-propanediolato) silane, n-(trimethoxysilylpropyl)ethylenediaminetriacetate, tripotassium salt, n-(trimethoxysilylpropyl)ethylenediaminetriacetate, trisodium salt, 1-[3-(2-aminoethyl)-3-aminoisobutyl]-1,1,3,3,3-pentaethoxy-1,3-disilapropane, bis(methyldiethoxysilylpropyl)amine, bis(methyldimethoxysilylpropyl)-n-methylamine, bis(3-triethoxysilylpropyl)amine, n,n′-bis[(3-trimethoxysilyl)propyl]ethylenediamine, tris(triethoxysilylpropyl)amine, tris(triethoxysilylmethyl)amine, bis[4-(triethoxysilyl)butyl]amine, tris[(3-diethoxymethylsilyl)propyl)amine, n-(hydroxyethyl)-n,n-bis(trimethoxysilylpropyl)amine, n-(hydroxyethyl)-n-methylaminopropyltrimethoxysilane, n-(3-methacryloxy-2-hydroxypropyl)-3-aminopropyltriethoxysilane, 3-(n-styrylmethyl-2-aminoethylamino)propyltrimethoxysilane, 3-(2,4-dinitrophenylamino)propyltriethoxysilane, 4-nitro-4(n-ethyl-n-trimethoxysilylcarbamato)aminoazobenzene, bis(diethylamino)dimethylsilane, bis(dimethylamino)diethylsilane, bis(dimethylamino)dimethylsilane, (diethylamino)trimethylsilane, (n,n-dimethylamino)trimethylsilane, tris(dimethylamino)methylsilane, n-butyldimethyl(dimethylamino)silane, n-decyltris(dimethylamino)silane, n-octadecyldiisobutyl(dimethylamino)silane, n-octadecyldimethyl(diethylamino)silane, n-octadecyldimethyl(dimethylamino)silane, n-octadecyltris(dimethylamino)silane, n-octyldiisopropyl(dimethylamino) silane, n-octyldimethyl(dimethylamino)silane, and any combination thereof. the examples of the benzylaminosilane system are n-(2-n-benzylaminoethyl)-3-aminopropyltrimethoxysilane, n-(2-n-benzylaminoethyl)-3-aminopropyltrimethoxysilane hydrochloride, n-benzylaminomethyltrimethylsilane, or any combination thereof. The example of benzylsilane system are benzyldimethylchlorosilane, benzyldimethylsilane, n-benzyl-n-methoxymethyl-n-(trimethylsilylmethyl)amine, benzyloxytrimethylsilane, benzyltrichlorosilane, benzyltriethoxysilane, benzyltrimethylsilane, bis(trimethylsilylmethyl)benzylamine, (4-bromobenzyl) trimethylsilane, dibenzyloxydiacetoxysilane, or any combination thereof. The examples of chloro and chlorosilane system are (−)-camphanyldimethylchlorosilane, 10-(carbomethoxy)decyldimethylchlorosilane, 10-(carbomethoxy)decyltrichlorosilane, 2-(carbomethoxy)ethylmethyldichlorosilane, 2-(carbomethoxy)ethyltrichlorosilane, 3-chloro-n,n-bis(trimethylsilyl)aniline, 4-chlorobutyldimethylchlorosilane, (chlorodimethylsilyl)-5-[2-(chlorodimethylsilyl)ethyl]bicycloheptane, 13-(chlorodimethylsilylmethyl)heptacosane, 11-(chlorodimethylsilyl)methyltricosane, 7-[3-(chlorodimethylsilyl)propoxy]-4-methylcoumarin, 2-chloroethylmethyldichlorosilane, 2-chloroethylmethyldimethoxysilane, 2-chloroethylsilane, 1-chloroethyltrichlorosilane, 2-chloroethyltrichlorosilane, 2-chloroethyltriethoxysilane, 1-chloroethyltrimethylsilane, 3-chloroisobutyldimethylchlorosilane, 3-chloroisobutyldimethylmethoxysilane, 3-chloroisobutylmethyldichlorosilane, 1-(3-chloroisobutyl)-1,1,3,3,3-pentachloro-1,3-disilapropane, 1-(3-chloroisobutyl)-1,1,3,3,3-pentaethoxy-1,3-disilapropane, 3-chloroisobutyltrimethoxysilane, 2-(chloromethyl)allyltrichlorosilane, 2-(chloromethyl)allyltrimethoxysilane, 3-[2-(4-chloromethylbenzyloxy)ethoxy]propyltrichlorosilane, chloromethyldimethylchlorosilane, chloromethyldimethylethoxysilane, chloromethyldimethylisopropoxysilane, chloromethyldimethylmethoxysilane, (chloromethyl)dimethylphenylsilane, chloromethyldimethylsilane, 3-(chloromethyl)heptamethyltrisiloxane, chloromethylmethyldichlorosilane, chloromethylmethyldiethoxysilane, chloromethylmethyldiisopropoxysilane, chloromethylmethyldimethoxysilane, chloromethylpentamethyldisiloxane, ((chloromethyl)phenylethyl)dimethylchlorosilane, ((chloromethyl)phenylethyl)methyldichlorosilane, ((chloromethyl)phenylethyl)methyldimethoxysilane, ((chloromethyl)phenylethyl)trichlorosilane, ((chloromethyl)phenylethyl)triethoxysilane, ((chloromethyl)phenylethyl)trimethoxysilane, chloromethylphenethyltris(trimethylsiloxy)silane, (p-chloromethyl)phenyltrichlorosilane, (p-chloromethyl)phenyltrimethoxysilane, chloromethylsilatrane, chloromethyltrichlorosilane, chloromethyltriethoxysilane, chloromethyltriisopropoxysilane, chloromethyltrimethoxysilane, chloromethyltrimethylsilane, 2-chloromethyl-3-trimethylsilyll-propene, chloromethyltris(trimethylsiloxy) silane, (5-chloro-1-pentynyl)trimethylsilane, chlorophenylmethyldichloro-silane, chlorophenyltrichlorosilane, chlorophenyltriethoxysilane, p-chlorophenyltriethoxysilane, p-chlorophenyltrimethylsilane, (3-chloropropoxy)isopropyldimethylsilane, (3-chloropropyl)(t-butoxy)dimethoxysilane, 3-chloropropyldimethylchlorosilane, 3-chloropropyldimethylethoxysilane, 3-chloropropyldimethylmethoxysilane, 3-chloropropyldimethylsilane, 3-chloropropyldiphenylmethylsilane, chloropropylmethyldichlorosilane, 3-chloropropylmethyldiethoxysilane, 3-chloropropylmethyldiisopropoxysilane, 3-chloropropylmethyldimethoxysilane, (3-chloropropyl)pentamethyldisiloxane, 3-chloropropyltrichlorosilane, 3-chloropropyltriethoxysilane, 3-chloropropyltrimethoxysilane, 3-chloropropyltrimethylsilane, 3-chloropropyltriphenoxysilane, 3-chloropropyltris(trimethylsiloxy)silane, 2-(4-chlorosulfonylphenyl)ethyltrichlorosilane, 2-(4-chlorosulfonylphenyl)ethyltrichlorosilane, 2-(4-chlorosulfonylphenyl)ethyltrimethoxysilane, 2-(4-chlorosulfonylphenyl)ethyltrimethoxysilane, 1-chloro-5-(trimethylsilyl)-4-pentyne, chlorotris(trimethylsilyl)silane, 11-chloroundecyltrichlorosilane, 11-chloroundecyltriethoxysilane, 11-chloroundecyltrimethoxysilane, 1-chlorovinyltrimethylsilane, (3-cyanobutyl)dimethylchlorosilane, (3-cyanobutyl)methyldichlorosilane, (3-cyanobutyl)trichlorosilane, 12-cyanododec-10-enyltrichlorosilane, 2-cyanoethylmethyldichlorosilane, 2-cyanoethyltrichlorosilane, 3-cyanopropyldiisopropylchlorosilane, 3-cyanopropyldimethylchlorosilane, 3-cyanopropylmethyldichlorosilane, 3-cyanopropylphenyldichlorosilane, 3-cyanopropyltrichlorosilane, 3-cyanopropyltriethoxysilane, 11-cyanoundecyltrichlorosilane, [2-(3-cyclohexenyl)ethyl]dimethylchlorosilane, [2-(3-cyclohexenyl)ethyl]methyldichlorosilane, [2-(3-cyclohexenyl)ethyl]trichlorosilane, 3-cyclohexenyltrichlorosilane, cyclohexyldimethylchlorosilane, cyclohexylmethyldichlorosilane, (cyclohexylmethyl)trichlorosilane, cyclohexyltrichlorosilane, (4-cyclooctenyl)trichlorosilane, cyclooctyltrichlorosilane, cyclopentamethylenedichlorosilane, cyclopentyltrichlorosilane, cyclotetramethylenedichlorosilane, cyclotrimethylenedichlorosilane, cyclotrimethylenemethylchlorosilane, 1,3-dichlorotetramethyldisiloxane, 1,3-dichlorotetraphenyldisiloxane, dicyclohexyldichlorosilane, dicyclopentyldichlorosilane, di-n-dodecyldichlorosilane, dodecylmethylsilyl)methyldichlorosilane, diethoxydichlorosilane, or any combination thereof. the examples of the epoxysilane system are 2-(3,4-epoxycyclohexyl) ethylmethyldiethoxysilane, 2-(3,4-epoxycyclohexyl) ethyltriethoxysilane, 2-(3,4-epoxycyclohexyl) ethyltrimethoxysilane, 5,6-epoxyhexyltriethoxysilane, (epoxypropyl)heptaisobutyl-T8-silsesquioxane, or any combination thereof. The example of mercaptosilane system are (mercaptomethyl)methyldiethoxysilan, 3-mercaptopropylmethyldimethoxysilane, 3-mercaptopropyltriethoxysilane, 3-mercaptopropyltrimethoxysilane, 3-mercaptopropyltrimethoxysilane, 3-mercaptopropyltrimethylsilane, 3-mercaptopropyltriphenoxysilane, 11-mercaptoundecyloxytrimethylsilane, 11-mercaptoundecyltrimethoxysilane, or any combination thereof. The examples of ureidosilane are ureidopropyltriethoxysilane, ureidopropyltrimethoxysilane, or any combination thereof. The examples of vinyl, vinylbenzylsilane system are vinyl(bromomethyl)dimethylsilane, (m,p-vinylbenzyloxy)trimethylsilane, vinyl-t-butyldimethylsilane, vinyl(chloromethyl)dimethoxysilane, vinyl(chloromethyl)dimethylsilane, 1-vinyl-3-(chloromethyl)-1,1,3,3-tetramethyldisiloxane, vinyldiethylmethylsilane, vinyldimethylchlorosilane, vinyldimethylethoxysilane, vinyldimethylfluorosilane, vinyldimethylsilane, vinyldi-n-octylmethylsilane, vinyldiphenylchlorosilane, vinyldiphenylethoxysilane, vinyldiphenylmethylsilane, vinyl(diphenylphosphinoethyl)dimethylsilane, vinyl(p-methoxyphenyl)dimethylsilane, vinylmethylbis(methylethylketoximino) silane, vinylmethylbis(methylisobutylketoximino) silane, vinylmethylbis(trimethylsiloxy)silane, vinylmethyldiacetoxysilane, vinylmethyldichlorosilane, vinylmethyldichlorosilane, vinylmethyldiethoxysilane, vinylmethyldimethoxysilane, 1-vinyl-1-methylsilacyclopentane, vinyloctyldichlorosilane, o-(vinyloxybutyl)-n-triethoxysilylpropyl carbamate, vinyloxytrimethylsilane, vinylpentamethyldisiloxane, vinylphenyldichlorosilane, vinylphenyldiethoxysilane, vinylphenyldimethylsilane, vinylphenylmethylchlorosilane, vinylphenylmethylmethoxysilane, vinylphenylmethylsilane, vinylsilatrane, vinyl-1,1,3,3-tetramethyldisiloxane, vinyltriacetoxysilane, vinyltri-t-butoxysilane, vinyltriethoxysilane, vinyltriethoxysilane, oligomeric hydrolysate, vinyltriethoxysilane-propyltriethoxysilane, oligomeric co-hydrolysate, vinyltriethylsilane, vinyl(trifluoromethyl)dimethylsilane, vinyl(3,3,3-trifluoropropyl)dimethylsilane, vinyltriisopropenoxysilane, vinyltriisopropoxysilane, vinyltrimethoxysilane, vinyltrimethoxysilane, oligomeric hydrolysate, vinyltrimethylsilane, vinyltriphenoxysilane, vinyltriphenylsilane, vinyltris(dimethylsiloxy)silane, vinyltris(2-methoxyethoxy)silane, vinyltris(1-methoxy-2-propoxy)silane, vinyltris(methylethylketoximino)silane, vinyltris(trimethylsiloxy)silane, or any combination thereof.

Illustrative examples of fluorinated alkyl/aryl silane include, but are not limited to, 4-fluorobenzyltrimethylsilane, (9-fluorenyl) methyldichlorosilane, (9-fluorenyl) trichlorosilane, 4-fluorophenyltrimethylsilane, 1,3-bis(tridecafluoro-1,1,2,2-tetrahydrooctyl) tetramethyldisiloxane, 1H, 1H,2H,2H-perfluorodecyltrimethoxysilane, 1H, 1H,2H,2H-perfluorodecyltrichlorosilane, 1H,1H,2H,2H-perfluorooctyltrichlorosilane, 1H, 1H,2H,2H-perfluorooctadecyltrichlorosilane, 1H,1H,2H,2H-Perfluorooctyltriethoxysilane, 1H, 1H,2H,2H-Perfluorododecyltrichlorosilane, Trimethoxy(3,3,3-trifluoropropyl)silane, tridecafluoro-1,1,2,2-tetrahydrooctyl-1-trimethoxysilane, tridecafluoro-1,1,2,2-tetrahydrooctyl-1-triethoxysilane, and any combination thereof.

Where an organofunctional resin is present, the organofunctional resin can be selected from the group consisting of epoxy, epoxy putty, ethylene-vinyl acetate, phenol formaldehyde resin, polyamide, polyester resins, polyethylene resin, polypropylene, polysulfides, polyurethane, polyvinyl acetate, polyvinyl alcohol, polyvinyl chloride (PVC), polyvinyl chloride emulsion (PVCE), polyvinylpyrrolidone, rubber cement, silicones, and any combination thereof. Organofunctional polyhedral oligomeric silsesquioxane (POSS) can be selected from the group consisting acrylates, alcohols, amines, carboxylic acids, epoxides, fluoroalkyls, halides, imides, methacrylates, molecular silicas, norbornenyls, olefins, polyethylenglycols (PEGs), silanes, silanols, thiols, and any combination thereof. Illustrative examples of acrylates POSS's include acryloisobutyl POSS, or any combination thereof. Illustrative examples of alcohols POSS are diol isobutyl POSS, Cyclohexanediol isobutyl POSS, Propanediol isobutyl POSS, Octa (3-hydroxy-3-methylbutyldimethylsiloxy) POSS, or any combination thereof. Illustrative examples of amines POSS are Aminopropylisobutyl POSS, Aminopropylisooctyl POSS, Aminoethylaminopropylisobutyl POSS, OctaAmmonium POSS, Aminophenylisobutyl POSS, Phenylaminopropyl POSS Cage Mixture, or any combination thereof. Illustrative examples of a Carboxylic Acids POSS are Maleamic Acid-Isobutyl POSS, OctaMaleamic Acid POSS, or any combination thereof. Illustrative examples of an epoxide are Epoxycyclohexylisobutyl POSS, Epoxycyclohexyl POSS Cage Mixture, Glycidyl POSS Cage Mixture, Glycidylisobutyl POSS, Triglycidylisobutyl POSS, Epoxycyclohexyl dimethylsilyl POSS, OctaGlycidyldimethylsilyl POSS, or any combination thereof. In the case of fluoroalkyl POSS examples are Trifluoropropyl POSS Cage Mixture, Trifluoropropylisobutyl POSS, or any combination thereof. In the case of halide POSS is Chloropropylisobutyl POSS, or any combination thereof. In the case of Imides POSS examples are POSS Maleimide Isobutyl, or any combination thereof. In the case of Methacrylates examples are Methacryloisobutyl POSS, Methacrylate Ethyl POSS, Methacrylate Isooctyl POSS, Methacryl POSS Cage Mixture, or any combination thereof. In the case of molecular silica POSS examples are DodecaPhenyl POSS, Isooctyl POSS Cage Mixture, Phenylisobutyl POSS, Phenylisooctyl POSS, Octaisobutyl POSS, OctaMethyl POSS, OctaPhenyl POSS, OctaTMA POSS, OctaTrimethylsiloxy POSS, or any combination thereof. In the case of Norbornenyls examples are NB1010-1,3-Bis(Norbornenylethyl)-1,1,3,3-tetramethyldisiloxane, Norbornenylethyldimethylchlorosilane, NorbornenylethylDiSilanolisobutyl POSS, Trisnorbornenylisobutyl POSS, or any combination thereof. In the case of Olefins example are Allyisobutyl POSS, Vinylisobutyl POSS, Vinyl POSS Cage Mixture, or any combination thereof. In the case of PEGs, examples include PEG POSS Cage Mixture, MethoxyPEGisobutyl POSS, or any combination thereof. In the case of a silane examples are OctaSilane POSS, or any combination thereof. In the case of silanols examples are DiSilanolisobutyl POSS, TriSilanolEthyl POSS, TriSilanolisobutyl POSS, TriSilanolisooctyl POSS, TriSilanolPhenyl POSS Lithium Salt, TrisilanolPhenyl POSS, TetraSilanolPhenyl POSS, or any combination thereof. In the case of thiols is Mercaptopropylisobutyl POSS, or any combination thereof.

In certain embodiments, another example of a coating that may be present on one or more surfaces of a hand drying apparatus comprises at least one additional layer comprising a lubricant, a polymer blend, nanoparticles, or any combination thereof, such as polymer-nanoparticle composite materials, that is infused inside the surface features of the textured layer. In this case the surface features can provide mechanical grips for the additional layer. Nanoparticles can either be treated with a low surface energy material in advance or a low surface energy material can be added to the chemical blend of the additional layer. High surface energy materials are more easily wet than low surface energy materials. Low surface energy materials usually exhibit a surface energy value less than 70 mJ/m² when measured according to the ASTM D7490-13 standard. Examples of low surface energy materials include but not limited to organofunctional silane, low-surface-energy resins, fluorinated alkylsiloxane, fluorinated alkylsilane, silicone polymers, organofunctional silicone polymers, organofunctional silicone copolymers, fluorinated polyhedral oligomeric silsesquioxane (FPOSS), organofunctional polyhedral oligomeric silsesquioxane (POSS), or any combination thereof. Examples of nanoparticles used in the structure of the additional layer include but not limited to silica (SiO₂), alumina (Al₂O₃), silicon carbide (SiC), diamond, diatomaceous earth (DE), boron nitride (BN), titanium oxide (TiO₂), single wall carbon nanotubes (SWCNTs), multi-wall carbon nanotubes (MWCNTs), kaolin (Al₂O₃.2SiO₂.2H₂O), or any combination thereof. In particular, nanoparticles can be hydrophobic ceramic-based particles.

In some instances, the polymer used in the structure of the additional layer can be selected from the group including but not limited to organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte (polymers that have some repeat groups that contains electrolytes), a poly ampholyte (Poly ampholytes are polyelectrolytes with both cationic and anionic repeat groups. There are different types of poly ampholyte. In the first type, both anionic and cationic groups can be neutralized. In the second type, anionic group can be neutralized, while cationic group is a group insensitive to pH changes such as a quaternary alkyl ammonium group. In the third type, cationic group can be neutralized and anionic group is selected from those species such as sulfonate groups that are showing no response to pH changes. In the fourth type, both anionic and cationic groups are insensitive to the useful range of pH changes in the solution), ionomers (an ionomer is a polymer comprising repeat units of electrically neutral and ionized units. Ionized units are covalently bonded to the polymer backbone as pendant group moieties and usually consist mole fraction of no more than 15 mole percent), oligomers, cross-linkers, or any combination thereof. Examples of organic polymers include, but are not limited, to polyacetals, polyolefins, polyacrylics, polycarbonates, polystyrenes, polyesters, polyamids, polyamidimides, polyacrylates, polyarylsulfones, polythersulfones, polyphenylene sulfides, polyvinylchlorides, polysulfones, polyimides, polyetherimides, polytetrafluoroethylenes, polyether ketone ketones, polybenzoxazoles, polyphthalides, polyacetals, polyanhydrides, polyvinyl ethers, polyvinyl thioethers, polyvinyl alcohols, polyvinyl ketones, poly vinyl halides, polyvinyl nitriles, polyvinyl esters, polysulfonates, poly sulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene ptopylene diene rubber (EPR), perfluoroelastomers, fluorinated ethylene propylene, perfluoroalkoxyethylene, poly-chlorotrifluoroethylene, polyvinylidene fluoride, polysiloxanes, or any combination thereof. Examples of polyelectrolytes include, but are not limited to, polystyrene sulfonic acid, polyacrylic acid, pectin, carrageenan, alginates, carboxymethylcellulose, polyvinylpyrrolidone, or any combination thereof. Examples of thermosetting polymers include, but are not limited to, epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, urea-formaldehyde polymers, novolacs, resoles, melamine-formaldehyde polymers, urea-formaldehyde polymers, hydroxymethylfuranes, isocyanates, diallyl phthalate, triallyl cyanurate, triallyl isocyanurate, unsaturated polysterimides, or any combination thereof. Examples of thermoplastic polymers include, but are not limited to, acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, poly sulfone/acrylonitrile-butadiene-styrene, polycarbonate/thermoplastic urethane, polycarbonate/polybutylene terephthalate, thermoplastic elastomer alloys, nylon/elastomers, polyester/elastomers, polyethylene terephthalate/polybutylene terephthalate, acetal/elastomer, styrene maleic anhydride/acrylonitrile-butadiene-styrene, polyether etherketone/polyethersulfone, polyether, etherketone/polyetherimide polyethylene/nylon, polyethylene/polyacetal, or any combination thereof.

In certain examples, processes other than electrodeposition processes can also be used in production of the coatings. The hydrophobic textured layer can be made, for example, through a process comprising a combination of the electrodeposition techniques and any other technique selected from the group consisting of annealing and thermal processing, vacuum conditioning, aging, plasma etching, grit blasting, wet etching, ion milling, exposure to electromagnetic radiation such as visible light, UV, and x-ray, other processes, and combinations thereof. In addition, the manufacturing process of the hydrophobic textured layer can be followed by at least one additional coating process selected from the group consisting of electrodeposition, electroless deposition, surface functionalization, electro-polymerization, spray coating, brush coating, dip coating, electrophoretic deposition, reaction with fluorine gas, plasma deposition, brush plating, chemical vapor deposition, sputtering, physical vapor deposition, passivation through the reaction of fluorine gas, any other coating technique, and any combination thereof.

In certain instances, the coating present on one or more drying apparatus surfaces can exhibit heat-resistant characteristics. This characteristic is observed if a water contact angle of the coating changes less than 20 percent after the coating is subjected to a thermal process at 100° C. or higher for 12 hours or longer.

In certain embodiments, the coating present on one or more drying apparatus surfaces described herein can be considered mechanically durable. Mechanical durability can be defined based on two criteria of hardness and pull-off (tape) tests. The hardness criterion is defined based on the pencil hardness level of more than 3B corresponding to the ASTM D3363-05(2011)e2 standard measurement. This test method determines the hardness of a coating by drawing pencil lead marks from known pencil hardness on the coating surface. The film hardness is determined based on the hardest pencil that will not rupture or scratch the film. A set of calibrated drawing leads or calibrated wood pencils meeting the following scales of hardness were used: 9H-8H-7H-6H-5H-4H-3H-2H-H-F-HB-B-2B-3B-4B-5B-6B-7B-8B-9B. 9B grade corresponds to the lowest level of hardness and represents very soft coatings. The hardness level increases gradually after that until it gets to the highest level of 9H. The difference between two adjacent scales can be considered as one unit of hardness.

In addition to the pencil hardness, durability of the coating can be characterized using the standard ASTM procedure for the tape test (ASTM F2452-04-2012). This attribute of durability is defined based on exhibiting at least level three of durability among five levels defined by the standard test. In this test, a tape is adhered to the surface and pulled away sharply. The level of the coating durability obtained based on the amount of the coating removed from the surface and attached to the tape. The lowest to highest durability is rated from 1 to 5, respectively. A lower rating means that some part of the coating was removed by the tape, and therefore, a part of the coating functionality was lost. Rate 5 corresponds to the condition that zero amount of coating is removed. Therefore, the functionally of the coating at this rate remains the same after and before the tape test.

In addition to the pencil hardness and tape tests, a Tabor abrasion test is another test that can be performed on the coatings described herein. In this test, the coated samples can be subjected to several cycles of abrasive wheels with 500 g loading weight at 60 rpm speed. The mass loss percentage (%) of the coatings can then be calculated for each individual sample based on the ratio of mass loss to the initial mass of the coating. Abrasion resistance of textured superhydrophobic coatings is generally less than hydrophobic coatings that do not have any surface texture.

In some embodiments, the coating described herein may be considered easy-clean coatings. Easy-clean characteristic is defined, wherein in a cleanability test, at least 80 percent of the surface can be cleaned. In this test, the coating can be painted with cooking oil and placed in an oven at 100° C. for 12 hours. It can then be wiped out with a wet tissue. Easy-clean characteristic is also related to the coating oleophobicity. The oleophobic characteristic can be measured by the contact angle of oil on a surface.

Without wishing to be bound by any particular theory, certain configurations of the coatings disclosed herein can work by trapping media such as gases or liquids between the structures of the surface texture. Other macroscopic objects may remain on top of the surface texture. Some part of the macroscopic object can be in contact with the media and not the surface. As a result, compared to uncoated surfaces, transfer between the macroscopic object and the coated surface is discouraged. Macroscopic objects include, but are not limited to, liquid droplets, a part of a human or animal body, tools and solid objects. The surface of the textured coating may have reduced loading by microscale and nanoscale objects, chemicals and molecules than a regular surface. For example, microscale and nanoscale objects include, but are not limited to, particles, microorganisms, viruses, etc. Chemicals and molecules include but are not limited to molten substances and fluids at high temperatures. In certain instances, the coatings can enable protection against undesirable consequences of contact between the surface and the macroscopic, microscale and/or nanoscale objects such as equipment damage, corrosion, transfer of germs, dirt, and smudge, friction and drag. In other instances, liquids may not stick to the coating surface. Liquids, for example, can be water, tap water, sea water, oil, acids, bases, or biological fluids such as blood and urine. In this example, liquid drops bead up on the coating surface, roll off the surface with a slight applied force, and bounce if dropped on the surface from a height. In fact, surface texture can result in such properties of the surface as super-repellency (e.g. superhydrophobicity and superoleophobicity).

In some instances, if the size of textures is small enough, the micro/nano scale objects may also stay on top of the surface features. Therefore, some part of the micro/nano scale object can be in contact with the media not the surface. In this scenario, less microscale and nanoscale objects get transferred to the surface. Even if they get transferred to the surface it will be easier to remove them, e.g., less sheer force or cleaning materials is required to remove microscale and nanoscale objects. The micro/nano scale objects can be microbes (such as bacteria, mold, mildew, fungi, etc.), viruses, particles and dirt.

In some examples, microscale and nanoscale objects may get entrapped between the structures of the surface texture but get transferred less to the macroscopic object touching the surface. In addition, the entrapment of microorganisms between topographical features may delay colonization of the surface through affecting different activities of microorganisms including but not limited to growth, motility, and cell to cell communication.

In some instances, the surface may be in contact with fluids including liquids and gases that contain particles, microorganisms, dirt, chemicals, reactive agents, macromolecules, etc. The liquid for example can be water, sea water, oil, acids, bases, or biological fluids such as blood and urine. At these conditions, surface texture can result in reducing the transfer of microscale and nanoscale objects, chemicals or/and reactive agents dissolved in fluid, etc. to the surface. The reason is surface texture can result in such properties of the surface as super-repellency (e.g. superhydrophobicity and superoleophobicity) or superwetting (e.g. superhydrophilicity or superoleophilicity).

In some examples, the shape of surface features can reduce the transfer to the surface or make the transfer from the surface easier. For instance, if the top of the surface features is not flat, i.e., it is sharp or curved, objects may make less contact area on engineered surface. In addition, microscopic objects may need to go through more/unusual deformation upon contact with an engineered surface with sharp or curved surface features. The deformation may not be favorable, for example due to the energetic costs associated with it. Therefore, the micro- and nanoscale objects may not attach to the surface or may loosely attach and consequently easily detach from the surface. In another example, a layer of fluid for example a vapor can be formed between the structures of the surface texture at high temperatures and discourages adhesion of the macroscopic object to the coated surface.

In some examples, the coatings disclosed herein can be deposited on the surface of a mold. The mold can be used for making textured surfaces by transferring the negative replica of the coating's texture into the surface of a polymer, ceramic, or glass components which form the drying apparatus in a molding process. Examples of the molding process include but not limiting to rotational molding, injection molding, blow molding, compression molding, film insert molding, gas assist molding, structural foam molding, and thermoforming.

In other examples, the drying apparatus described herein may comprise at least one textured coating and/or a surface coating. For example, the articles described herein may comprise one or more textured coatings which can be used to enhance adhesion or sticking of a surface coating. In some examples, the textured coating is provided using suitable techniques as described herein, e.g., electrodeposition, and comprises a plurality of individual microstructures of a first size, e.g., the microstructures may comprise an average diameter of 15 microns or less, or 10 microns or less or 5 microns or less or 0.5 microns or less. The surface coating can comprise particles or materials with an average size less than the first size of the microstructures of the textured coating. As noted herein, by tuning the size and/or shape of the textured coating and the material of the surface coating, enhanced adhesion of the surface coating can be achieved. Drying apparatus with textured coatings and surface coatings may provide, for example, enhanced resistance to microbial growth. For example, the adhesion or pull-off strength of the surface coating present on a drying apparatus may be 10%, 20%, 30%, 40%, 50%, 60%, 70%, 80% or even 90% higher when the textured coating is present compared to the pull-off strength of the surface coating being disposed on a substrate not having the same textured coating. As discussed herein, pull-off strength can be tested, for example, using ASTM D4541-09. In some configurations, the pull-off strength of the surface coating, when the textured coating is present, may be at least 200 psi, 225 psi or 250 psi as tested using ASTM D4541-09. In some examples, the coatings can be present as distinct layers with a defined interface, whereas in other instances, the coating materials may infuse or penetrate into each other without a discernible interface between them.

In certain examples, one or more surfaces of a drying apparatus may comprise a surface coating disposed on the textured coating. As noted in more detail below, the surface coating may comprise a repellent material, a material with a water contact angle greater than 80 degrees, a water roll off angle below 20 degrees, an oil roll off angle below 45 degrees and combinations thereof. Wetting properties of the surface can be measured based on the procedures explained in the following standards: ASTM D7490-13, ASTM D724-99, ASTM 0 5946-2004, and ISO 15989. In some examples, the repellent materials may generally be considered “non-stick” materials in the field of coatings. When the surface coating is absent, the overall surface roughness of the article is typically higher, e.g., surface roughness decreases after the surface coating is applied to the textured coating.

In certain configurations described herein, the textured coating present on one or more surfaces of a drying apparatus can be configured as a porous coating to permit the surface coating material to penetrate or infuse into the void space of the textured coating. For example, there may be space between microstructures of the textured coating and/or space within the microstructures themselves that permits the surface coating material to infuse, enter or penetrate into the textured coating. Infusion or entry of the surface coating material into the textured coating can reduce the overall surface roughness, e.g., the surface roughness once the textured coating has been disposed on the article is much higher than the surface roughness once the surface coating has been disposed on the textured coating. As noted herein, the textured coating and surface coatings can each be applied in numerous manners including, but not limited to, brushing, spraying, dip-coating, jet coating or other methods. In some examples, the textured coating can be applied using electrodeposition and the surface coating can be applied using non-electrodeposition methods.

In other instances, a textured coating can be disposed on an already existing textured coating. For example, a drying apparatus surface may comprise a first textured coating, and another textured coating can be disposed on the first textured coating. In other instances, a first textured coating can be applied to the drying apparatus surface, e.g., using electrodeposition or other processes, and then a second textured coating can be applied to the drying apparatus surface and/or the applied to the first textured coating. A surface coating can then be applied to the textured coatings on the drying apparatus surface. In some case, the first and second textured coatings may comprise the same material but have different microstructures or topography. In other cases, the first and second textured coatings may comprise a different material but have similarly shaped microstructures or topography. In additional examples, the first and second textured coatings may comprise different materials and have different microstructures or topography. If desired, one or both of the first and second textured coatings can be electrodeposited onto a drying apparatus surface, or, one of the textured coatings can be electrodeposited and the other textured coating can be disposed using means other than electrodeposition.

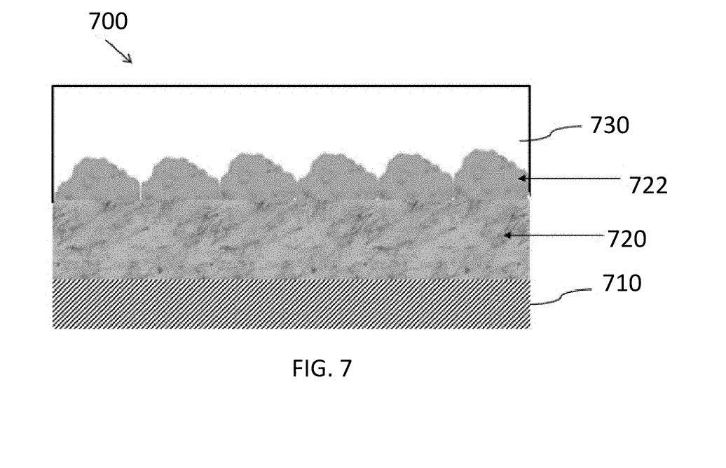

In certain examples and referring to FIG. 7, a section of a drying apparatus 700 is shown that comprises a surface 710, a textured coating 720 disposed on the surface 710 and a surface coating 730 disposed on the textured coating 720. As noted in more detail herein, the textured coating 720 may comprise one or more individual microstructures or features such as microstructure 722. The space present between various microstructures can be filled by material of the surface coating 730 to enhance grip or adhesion of the surface coating 730 in the article 700. Various materials for the surface 710 are described below and include, for example, plastics, steels, steel alloys, steel comprising different grades of carbon steel or stainless steel. Similarly, various materials for the textured coating 720 are described herein and include, but are not limited to, metals or metallic compounds optionally in combination with other materials. Various materials for the surface coating 730 are described below and include, but are not limited to, different polymers such as fluorinated or silicon-based polymers, ceramics, polymer blends, repellent and/or hydrophobic or superhydrophobic materials, nanoparticles, or any combination thereof such as polymer-nanoparticle composite materials. It is worth mentioning that repellent materials are defined as the materials that can repel one or more substances including, but not limited to, water, oil, smudge, dirt, and dust, for example.

In some embodiments, the textured coating 720 can be provided as described herein, e.g., using one or more electrodeposition processes and/or systems. Further, additional process steps, such as, for example, grit blasting, plasma etching, electroless deposition, wet etching, ion milling, surface functionalization, electro-polymerization, spray coating, brush coating, electrophoretic deposition, thermal processes, vacuum conditioning, exposure to electromagnetic radiation such as visible light, UV, and x-ray exposure may also be performed. The electrolyte solution used to provide the textured coating 720 may also comprise other compounds including but not limited to ionic compounds to enhance electrolyte conductivity, buffer compounds to stabilize electrolyte pH, and different additives. Examples of additives include but not limited to thiourea, acetone, cadmium ion, chloride ion, stearic acid, ethylenediamine dihydrochloride, saccharin, cetyltrimethylammonium bromide, ethyl vanillin, ammonia, ethylene diamine, polyethylene glycol (PEG), bis(3-sulfopropyl)disulfide (SPS), Janus green B (JGB), the polyoxyethylene family of surface active agents, sodium citrate, perfluorinated alkylsulfate, additive K, ethylene diamine, ammonium chloride. In addition to these additives, one or more repellent or hydrophobic materials may also be present in the electrolyte solution itself, e.g., can be dispersed or suspended or dissolved in the electrolyte solution as desired.

In some examples, the surface 710 can be cleaned or washed prior to deposition of the textured coating. Different cleaning processes including, but not limited to, pickling, acid wash, saponification, vapor degreasing, and alkaline wash may be used for cleaning the substrate. The cleaning process may include, but is not limited to, removal of the inactivate oxides by acid wash or pickling and catalytic deposition of a seed layer. If desired, however, the substrate may not be subjected to physical pre-treatment steps that significantly alter the overall surface characteristics of the substrate prior to electrodeposition of the textured coating. For example, the substrate can be washed or treated without significantly altering the native material present in the substrate or removal of any native material from the substrate. Similarly, if desired, the substrate may not be subjected to chemical pre-treatment steps that alter the overall surface characteristics of the substrate prior to electrodeposition of the textured coating or remove any significant amount of the native substrate material from the substrate prior to electrodeposition of the textured coating. The change in the surface characteristics and the amount of the material that is removed from the surface during the cleaning process is not considered significant. In certain examples, the surface 410 can be a part of the cathode of the electrodeposition system. The surface 410 may comprise any material that may be electroplated including metals, alloys, plastics, composites, and ceramics. In some examples, the substrate may be a non-anodizable substrate, steel, steel alloys, steel comprising different grades of carbon steel or stainless steel. In other examples, an intermediate layer can be applied between the substrate and the electrodeposited textured coating. The substrate can be conductive or non-conductive. However, for non-conductive substrates an intermediate activation layer or seed layer may be applied before the electrodeposition process.

In certain embodiments, the surface coating 730 may comprise a surface coating which is generally a repellent or hydrophobic coating of a different composition than that present in the textured coating, though one or more common materials may be present in the textured coating and the surface coating. In conventional repellent coatings, adhesion to different metallic substrates is poor. Adhering repellent coatings to metallic substrates usually requires considerable surface preparation. This preparation process usually includes roughening the metal surface for example by grit blasting. Roughened surfaces are expected to improve adhesion between repellent coatings and the base substrates due to mechanical coupling. However, in some cases the created roughness does not provide enough adhesion. Moreover, for some applications, such as those involved in coating geometrically complex surfaces and hard-to-reach areas, obtaining a properly roughened surface using existing methods such as grit-blasting is either impossible or very difficult. One approach to solve these problems is creating roughness by anodization instead of grit-blasting. However, anodization can just be applied to a few metals and some of the commonly-used metals such as steels or carbon steel cannot be anodized.

Due to these reasons, in spite of great advantages of repellent coatings for some applications, a practical way for applying them on many objects does not exist. For example, new materials and processes that enable successful application of repellent coatings on large and partially enclosed structures such as the drying apparatus described herein cooktops would be desirable. If desired, the surface coating may only be present on internal surfaces of the drying apparatus as well. In other examples, substantially all exterior surfaces of the drying apparatus may comprise a textured coating and/or a surface coating. In some examples, the surface coating can be present on internal surfaces of an article which may inadvertently contact water during the drying operation.

In some examples, the surface coating present in the articles described herein may comprise one or more polytetrafluoroethylene (PTFE) coatings such as Teflon® coatings, Xylan® coatings, Excalibur® coatings, Sunoloy® coatings, Solvay Solexis Halar® coatings, Wearlon® coatings. In other examples, the surface coating comprises one or more ceramic coatings such as Thermolon™ coatings or Cerakote™ coatings. In additional examples, the surface coating comprises one or more metal based coating such as molybdenum disulfide coatings, e.g., Dow Corning Molykote®. Mixtures of these various materials may also be used as surface coatings. Illustrative commercial companies which produce materials that can be used in the surface coatings including, but are not limited to, Dow Corning (Midland, Mich.), Sandstrom (Port Byron, Ill.), and Sun Coating Company (Plymouth, Mich.). As noted herein, the surface coating material can be used in particle form, powder form or other forms which can be easily applied to the textured coating. The textured coating can be pre-heated prior to application of the surface coating or may remain at room temperature or be cooled. Similarly, the surface coating material can be heated (or cooled) prior to application to the textured coating.

In some configurations, the surface coating is typically disposed on the textured coating using a non-electrodeposition process, such as, for example, spraying, brushing, dipping, spreading, jet coating, sol gel processing or other processes. In some examples, the average particle size of the surface coating, prior to disposition, may be about 50% less, 40% less, 30% less or 25% less than the first size, e.g., the average characteristic length, of the microstructures of the textured coating. For example, the textured coating may be electrodeposited onto the substrate, and SEM images or other suitable techniques can be used to determine an average characteristic length of the microstructures of the textured coating. The average particle size of the surface coating to be applied to the textured coating may then be selected to be less than the average characteristic length of the microstructures. Without wishing to be bound by any particular application method, a dispersion of particles comprising the surface coating material is typically produced. This dispersion may comprise an aqueous carrier, an organic carrier or mixtures thereof as desired to permit application of the surface coating material to the electrodeposited textured coating. Post-application of the surface coating material, the article can be subjected to other treatment steps including, but not limited to, drying, heating, cooling, blotting, annealing, tempering, consolidating, sanding, etching, polishing or other physical or chemical steps.

In some examples, an additional layer of material can be applied to the applied surface coating if desired. In other instances, the textured coating, the surface coating or both may each comprise one or more additional materials such as a polymeric material. The additional material (or additional layer) can be selected from the group including, but not limited, to organic polymers, thermoplastic polymers, thermosetting polymers, copolymers, terpolymers, a block copolymer, an alternating block copolymer, a random polymer, homopolymer, a random copolymer, a random block copolymer, a graft copolymer, a star block copolymer, a dendrimer, a poly electrolyte (polymers that have some repeat groups that contains electrolytes), a poly ampholyte (Poly ampholytes are polyelectrolytes with both cationic and anionic repeat groups. There are different types of poly ampholyte. In the first type, both anionic and cationic groups can be neutralized. In the second type, anionic group can be neutralized, while cationic group is a group insensitive to pH changes such as a quaternary alkyl ammonium group. In the third type, cationic group can be neutralized and anionic group is selected from those species such as sulfonate groups that are showing no response to pH changes. In the fourth type, both anionic and cationic groups are insensitive to the useful range of pH changes in the solution), ionomers (an ionomer is a polymer comprising repeat units of electrically neutral and ionized units. Ionized units are covalently bonded to the polymer backbone as pendant group moieties and usually consist mole fraction of no more than 15 mole percent), oligomers, cross-linkers, or any combination thereof. Examples of organic polymers include, but are not limited, to polyacetals, polyolefins, polyacrylics, polycarbonates, polystyrenes, polyesters, polyamides, polyamidimides, polyacrylates, polyarylsulfones, polyethersulfones, polyphenylene sulfides, polyvinylchlorides, polysulfones, polyimides, polyetherimides, polytetrafluoroethylenes, polyether ketone ketones, polybenzoxazoles, polyphthalides, polyacetals, polyanhydrides, polyvinyl ethers, polyvinyl thioethers, polyvinyl alcohols, polyvinyl ketones, poly vinyl halides, polyvinyl nitriles, polyvinyl esters, polysulfonates, poly sulfides, polythioesters, polysulfones, polysulfonamides, polyureas, polyphosphazenes, polysilazanes, styrene acrylonitrile, acrylonitrile-butadiene-styrene (ABS), polyethylene terephthalate, polybutylene terephthalate, polyurethane, ethylene ptopylene diene rubber (EPR), perfluoroelastomers, fluorinated ethylene propylene, perfluoroalkoxyethylene, poly-chlorotrifluoroethylene, polyvinylidene fluoride, polysiloxanes, or any combination thereof. Examples of polyelectrolytes include, but are not limited to, polystyrene sulfonic acid, polyacrylic acid, pectin, carrageenan, alginates, carboxymethylcellulose, polyvinylpyrrolidone, or any combination thereof. Examples of thermosetting polymers include, but are not limited to, epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, urea-formaldehyde polymers, novolacs, resoles, melamine-formaldehyde polymers, urea-formaldehyde polymers, hydroxymethylfuranes, isocyanates, diallyl phthalate, triallyl cyanurate, triallyl isocyanurate, unsaturated polysterimides, or any combination thereof. Examples of thermoplastic polymers include, but are not limited to, acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, poly sulfone/acrylonitrile-butadiene-styrene, polycarbonate/thermoplastic urethane, polycarbonate/polybutylene terephthalate, thermoplastic elastomer alloys, nylon/elastomers, polyester/elastomers, polyethylene terephthalate/polybutylene terephthalate, acetal/elastomer, styrene maleic anhydride/acrylonitrile-butadiene-styrene, polyether etherketone/polyethersulfone, polyether, etherketone/polyetherimide polyethylene/nylon, polyethylene/polyacetal, or any combination thereof.

In certain examples, processes other than electrodeposition processes can also be used in production of the surface coatings. The surface coating can be provided, for example, through a process comprising a combination of the electrodeposition techniques and any other technique selected from the group consisting of annealing and thermal processing, vacuum conditioning, aging, plasma etching, grit blasting, wet etching, ion milling, exposure to electromagnetic radiation such as visible light, UV, and x-ray, other processes, and combinations thereof. In addition, the manufacturing process of the textured coating can be followed by at least one additional coating process selected from the group consisting of electrodeposition, electroless deposition, surface functionalization, electro-polymerization, spray coating, brush coating, dip coating, electrophoretic deposition, reaction with fluorine gas, plasma deposition, brush plating, chemical vapor deposition, sputtering, physical vapor deposition, passivation through the reaction of fluorine gas, any other coating technique, and any combination thereof.

In certain instances, the textured coating, surface coating or both can exhibit heat-resistant characteristics. This characteristic is observed if water contact angle of the coating changes less than 20 percent after the coating is subjected to a thermal process at 100° C. or higher for 12 hours or longer.

In certain embodiments, the surface coatings disposed thereon can be considered mechanically durable. Mechanical durability can be defined based on two criteria of hardness and pull-off (tape) tests. The hardness criterion is defined based on the pencil hardness level of more than 3B corresponding to the ASTM D3363-05(2011)e2 standard measurement. This test method determines the hardness of a coating by drawing pencil lead marks from known pencil hardness on the coating surface. The film hardness is determined based on the hardest pencil that will not rupture or scratch the film. A set of calibrated drawing leads or calibrated wood pencils meeting the following scales of hardness were used: 9H-8H-7H-6H-5H-4H-3H-2H-H-F-HB-B-2B-3B-4B-5B-6B-7B-8B-9B. 9B grade corresponds to the lowest level of hardness and represents very soft coatings. The hardness level increases gradually after that until it gets to the highest level of 9H. The difference between two adjacent scales can be considered as one unit of hardness.

In addition to the pencil hardness, durability of the surface coating can be characterized using the standard ASTM procedure for the tape test (ASTM F2452-04-2012). This attribute of durability is defined based on exhibiting at least level three of durability among five levels defined by the standard test. In this test, a tape is adhered to the surface and pulled away sharply. The level of the coating durability obtained based on the amount of the coating removed from the surface and attached to the tape. The lowest to highest durability is rated from 1 to 5, respectively. A lower rating means that some part of the coating is removed by the tape, and therefore, a part of the coating functionality is lost. A rating of 5 corresponds to the condition that zero amount of coating is removed. Therefore, the functionally of the coating at this rate remains the same after and before the tape test.

In addition to the pencil hardness and tape tests, a Tabor abrasion test is another test that can be performed on the surface coatings described herein. In this test, the coated samples are subjected to several cycles of abrasive wheels with 500 g loading weight at 60 rpm speed. The mass loss percentage (%) of the coatings is then calculated for each individual sample based on the ratio of mass loss to the initial mass of the coating.

In some embodiments, the drying apparatus with a surface coating present on a textured coating may be considered “easy-clean.” Easy-clean characteristic is defined, wherein in a cleanability test, at least 80 percent of the surface can be cleaned. In this test, the coating is painted with cooking oil and placed in an oven at 100° C. for 12 hours. It can then be wiped out with a wet tissue. Easy-clean characteristic is also related to the coating oleophobicity. The oleophobic characteristic can be measured by the contact angle of oil on a surface.

In some examples, the pull-off strength of the surface coatings described herein, when tested by ASTM D4541-09, may be at least 200 psi or 225 psi or 250 psi when the textured coating is present. In other instances, the pull-off strength of the surface coating can increase by at least 10%, 20%, 30%, 40%, 50% or more when the textured coating is present on the substrate as compared to the pull-off strength when the textured coating is absent from the substrate.

In certain embodiments, the textured coating and/or surface coating may be provided by way of a kit which comprises suitable materials and instructions for providing a textured coating and/or surface coating on one or more surfaces of a drying apparatus. For example, a kit comprising a material to be applied as a textured coating and a material to be applied as a surface coating is provided. For example, the material for the textured coating may comprise nickel, zinc, chromium, copper, zinc/nickel alloys, zinc/copper alloys, chromium alloys and combinations thereof. The material for the textured coating may also comprise silicon carbide, polytetrafluoroethylene, silicon oxide, diamond, titanium dioxide or silicon oxide particles, microparticles or nanoparticles. The material for the surface coating may comprise one or more repellent materials such as, for example, one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof. If desired, the kit may also comprise instructions for using the various materials to provide an article including the substrate, the textured coating and the surface coating.

In other embodiments, a kit may comprise an electrolyte solution, or materials which can be used to prepare an electrolyte solution, and instructions for using the electrolyte solution to provide an electrodeposited textured coating on a substrate. For example, the electrolyte solution can be prepared from materials comprising nickel, zinc, chromium, copper, zinc/nickel alloys, zinc/copper alloys, chromium alloys and combinations thereof. The materials for preparing the electrolyte solution may also comprise silicon carbide, polytetrafluoroethylene, silicon oxide, diamond, titanium dioxide or silicon oxide particles, microparticles or nanoparticles. In some examples, the kit may also comprise a surface coating material and instructions for applying the surface coating material to the electrodeposited, textured coating. For example, one or more of a silicone polymer, e.g., polydimethylsiloxane, a fluorinated polymer, e.g., polytetrafluorethylene, an oligomeric siloxane, e.g., fluorinated-base oligomeric siloxane, a ceramic material, e.g., hydrophobic silica particles or alumina particles, a metal compound e.g., molybdenum disulfide, and combinations thereof, and the like can be present and used in the surface coating. In further embodiments, the kit may comprise the substrate itself. For example, the substrate may be steel, a steel alloy, steel comprising different grades of carbon steel or stainless steel. Other components may also be present in the kit.

When introducing elements of the aspects, embodiments, configurations, examples, etc. disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A drying apparatus configured to provide a gas flow to remove liquid droplets from an object, the drying apparatus comprising a drying cavity comprising an inner wall surface, wherein at least some portion of the inner wall surface comprises a hydrophobic material, wherein at least 90 percent of the surface of the hydrophobic material remains free of the liquid droplets after the drying operation.

2. The drying apparatus of claim 1, further comprising a heater.

3. The drying apparatus of claim 2, further comprising a jet configured to provide a high pressure airstream to dry the received portion of the object.

4. The drying apparatus of claim 1, wherein said hydrophobic material is a coating applied on all or some parts of the inner wall surface of the drying cavity.

5. The drying apparatus of claim 1, wherein the hydrophobic material is present in an elastic sheet applied on some portion of the drying cavity.

6. The drying apparatus of claim 1, wherein said drying apparatus is configured as a hand dryer, and wherein the drying cavity is sized and arranged to receive a portion of a human hand.

7. The drying apparatus of claim 6, wherein said hydrophobic material is present on all exterior surface of the hand dryer.

8. The drying apparatus of claim 1, wherein the hydrophobic material comprises a textured surface comprising a plurality of individual surface features in a micro- or nano-structure size range.

9. The drying apparatus of claim 7, further comprising an additional layer disposed on the textured surface, wherein the additional layer comprises a lubricant, a polymer blend, nanoparticles, or any combination thereof such as polymer-nanoparticle composite materials is infused inside the surface features of the textured surface.

10. The drying apparatus of claim 8, wherein the additional layer comprises the nanoparticles and the nanoparticles are either treated with a low surface energy material in advance or a low surface energy material is added to the chemical blend of the additional layer.

11. The drying apparatus of claim 8, wherein the nanoparticles are selected from the group comprising PTFE particles, silica particles, alumina particles, silicon carbide, diatomaceous earth, boron nitride, titanium oxide, platinum oxide, diamond, particles formed from differential etching of spinodally decomposed glass, single wall carbon nanotubes, mix silicon/titanium oxide particles (TiO2/SiO2, titanium inner core/silicon outer surface), ceramic particles, thermo-chromic metal oxide, multi-wall carbon nanotubes, kaolin (Al₂O₃.2SiO₂.2H₂O), any chemically or physically modified versions of the foregoing particles, and any combinations thereof.

12. The drying apparatus of claim 8, wherein the additional layer comprises the nanoparticles and wherein the nanoparticles comprise hydrophobic ceramic-based particles selected from the group including but not limited to hydrophobic fumed silica particles, hydrophobic diatomaceous earth (DE) particles, hydrophobic pyrogenic silica particles or any combination thereof.

13. The drying apparatus of claim 1, wherein the hydrophobic material (either the textured surface or the additional layer) comprises one or more of (i) an inorganic compound selected from the group consisting of ceramics, metallic compounds, inorganic oxides, inorganic carbides, inorganic nitrides, inorganic hydroxides, inorganic oxides having hydroxide coatings, inorganic carbonitrides, inorganic oxynitrides, inorganic borides, inorganic borocarbides, inorganic fluorides, and a combination comprising at least one of the foregoing inorganic compounds; or (ii) organic or inorganic-organic compounds selected from the group consisting of silane derivatives, fluorine derivatives, organofunctional silanes, fluorinated alkylsilane, fluorinated alkylsiloxane, organofunctional resins, hybrid inorganic organofunctional resins, organofunctional polyhedral oligomeric silsesquioxane (POSS), hybrid inorganic organofunctional POSS resins, fluorinated oligomeric polysiloxane, organofunctional oligomeric poly siloxane, fluorinated organofunctional silicone copolymers, organofunctional silicone polymers, hybrid inorganic organofunctional silicone polymers, organofunctional silicone copolymers, hybrid inorganic organofunctional silicone copolymers, fluorinated polyhedral oligomeric silsesquioxane (FPOSS), and a combination comprising at least one of the foregoing organic or inorganic-organic compounds; or (iii) a polymer selected from the group consisting of a fluoropolymer, a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polytetrafluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, a polyurethane, an ethylene propylene diene rubber, a polytetrafluoroethylene, a perfluoroelastomer, a fluorinated polyalkylene, a perfluoroalkoxyethylene, a polychlorotrifluoroethylene, a polyvinyldiene fluoride, a polysiloxane, a polyalkylene, a fluoro alkyl silane, a polyvinylfluoride, thermoplastic polymers such as acrylonitrile butadiene styrene (ABS) and polycarbonates (PC), thermosetting polymers, copolymers, terpolymers, a block copolymer, an alternating block copolymer, a random polymer, homopolymers, a random copolymer, a random block copolymer, a graft copolymer, a star block copolymer, a dendrimer, a poly electrolyte, a polyampholyte (a polyelectrolyte having both cationic and anionic repeat groups), an ionomer, parylene, silicone polymers, or a combination comprising at least one of the foregoing polymers, or (iv) a combination comprising at least one of the foregoing inorganic compounds, organic compounds, inorganic-organic compounds, and polymers.

14. The drying apparatus of claim 1, wherein all surfaces of the drying cavity comprise the hydrophobic material.

15. The drying apparatus of claim 1, wherein the hydrophobic material comprises a water contact angle of more than 90 degrees as tested by the ASTM D7490-13 standard.

16. The drying apparatus of claim 1, wherein the hydrophobic material has a pencil hardness level of more than 3B as tested by ASTM D3363-05(2011)e2 standard.

17. The drying apparatus of claim 1, wherein the hydrophobic material meets at least level three of durability in the pull-off test (tape test) as tested by the ASTM F2452-04-2012 standard.

18. A drying apparatus configured to receive at least some portion of a human hand within a drying cavity configured to remove liquid droplets from the received portion of the human hand, the drying cavity comprising an inner wall surface comprising a hydrophobic material that remains 90 percent free of the liquid droplets after the drying operation, wherein the hydrophobic material comprises:
a textured layer comprising a plurality of individual surface features in a micro- or nano-structure size range; and
a surface layer disposed on the textured layer.

19. The drying apparatus of claim 18, wherein pull-off strength of the disposed surface layer in the absence of the textured layer is lower than in the presence of the textured layer.

20. The drying apparatus of claim 19, wherein the surface layer comprises at least one repellent material.

21-53. (canceled)
